(19) United States
(12) Patent Application Publication
(10) Pub. No.: US 2021/0011967 A1
(43) Pub. Date: Jan. 14, 2021

(54) Consolidated feed or timeline of added users

(71) Applicant: Yogesh Rathod, Mumbai (IN)

(72) Inventor: Yogesh Rathod, Mumbai (IN)

(21) Appl. No.: 16/907,202

(22) Filed: Jun. 20, 2020

Related U.S. Application Data
(63) Continuation of application No. PCT/IB2017/058390, filed on Dec. 23, 2017.

(51) Int. Cl. G06F 16/9538; G06F 16/9535; G06F 16/9537; G06F 16/958

(52) U.S. Cl. CPC G06F 16/9538; G06F 16/958; G06F 16/9537; G06F 16/9535

(57) ABSTRACT

A server, method, system, device, apparatus, platform, application and service is disclosed for receiving request to access and view updated contents or posts of added users by requesting user; retrieving one or more types of contents or posts associated with each said added users; generating web page or user interface comprises said retrieved contents or posts of each said added users, wherein vertically order row representing each added user based on date and time of new or updated posted contents or posts by added users and horizontally order contents or posts posted or updated by each said corresponding added users in chronological order and displaying said generated web page or user interface.

### FIELD OF INVENTION

The present invention relates generally to providing list of user identities or contacts based on user provided one or more types of indications for posting contents, advertising, communicating, collaborating, participating and sharing. The present invention also relates to posting message to target criteria specific followers and receiving preferences specific messages from followed sources and present added sources associated updated web pages or interfaces in user's feed page.

### BACKGROUND OF THE INVENTION

Currently user can send email based on e-mail address, call to other user based on phone number, send message based on instant messenger credentials, post message in social network to connected users, send or post message to followers based on storing of followers of user when other users follow user.

User provides various types of indications by taking one or more user actions including Like from post, profile page or web page or list item or search result item, Share one or more types of contents, Reply message, Add to wish list one or more products and services, Bookmark or Favorite people, source, web page, web site, products, services, & items, watch video, view or read blog or post, listen music, purchase product, subscribe service, participate in event or group, provide user location & checked-in place to connected users of user, provide particular type of status, search contents, applications, services, products & websites from one or more web sites and applications including social networks, search engines, e-commerce websites, communication applications. Server accumulates or logs or stores various types of user indications, actions, activities, events, transactions, status, reactions, and behaviours. Advertiser can post advertisement based on target criteria or send advertisement post to identified followers of advertiser who follows advertiser. Present invention creates list of users including user identities, user contacts, user profile, various types of user data based on various types of user indications including users who liked or favorite or bookmarked or add to wish list or other type(s) of list particular web page, profile page, brand, user, post, named entity, product, service, item, place, web site, application, one or more types of contents or media including photo and video, category or keyword specific contents, list of users who searches based on particular keywords, list of users who check-in particular place or location, list of users who bought particular product or subscribe service and allow to access or filter said created list of users to advertisers or other users fore enabling them to post one or more types of content item(s) or collaborate or communicate message(s) to said one or more types of lists of users or filtered users or criteria or query specific users.

By employing various types of data analytics on user data including various types of user indications or actions from one or more types of contents, categories or types of contents, websites, applications including like particular post or web page or profile page, search based on particular keyword(s), follow, favorite, bookmark, buy, book, get appointment, watch, listen, visit, view, read, reply, comment, share, install application, provide tags, provide status, provide check-in place or user current location information, system can provide various types of list of users or provide list of provided criteria specific users to requesting user or advertisers for enabling them to select criteria specific users and send them one or more posts or one or more types of contents including photo, video, text, link, and user actions and communicate with them by using one or more communication applications including send and receive messages.

Google Adwords™ presents advertisement to real-time searching user based on matching searching keywords with advertisement associated keywords and target criteria. But does not enable advertisers to communicate with or send post(s) to keyword(s) specific users, who searched particular keywords. For example in present invention server monitors, tracks, logs, stores, and updates searching user's identity, user profile, user data and associated all searching keywords, clicked search result item associated keywords, visited websites, liked or view web page(s) associated relevant keywords and provided keyword(s), categories, key phrase(s), query specific users to advertisers, so advertiser can send or present post or message or one or more types of contents to feed or timeline or inbox or profile page or web page or interface of one or more selected or filtered keyword(s), categories, key phrase(s), query specific users or can communicate or collaborate or participate with one or more selected or filtered keyword(s), categories, key phrase(s), query specific users. Advertisers can further apply one or more criteria including age range, type of gender, location(s) specific users from keyword(s), categories, key phrase(s), and query specific users. For example advertiser send or present post or one or more types of contents to users who searches “patent attorney” and further limits to users who lives in USA.

Google™ AdWords™ Customer Match lets you show ads to your customers based on the data about those customers that you share with Google. Customer Match is a useful advertising tool for many business goals, from increasing brand awareness to driving performance.

AdWords™ Customer Match lets you show ads to your customers based on the data about those customers that you share with Google™. Customer Match is a useful advertising tool for many business goals, from increasing brand awareness to driving performance. The “Similar audiences” targeting option helps you find people who share characteristics with your site visitors. By adding “similar audiences” to your ad group, you can show your ads to people whose interests are similar to those of your site visitors, which allows you to reach new and qualified potential customers.

Google™ AdWords™ doesn't provide interface to advertiser to post contents on users feed or timeline or inbox or interface based on advertiser selected keywords including similar keywords (broad match, phrase match and exact match) which matched with all users who searched contents in post based on said selected keyword(s) or similar types of keyword(s) (broad match, phrase match and exact match) and further filter said selected keyword(s) specific users by providing one or more criteria including location, age range, gender, skill, interest type, education, company, school, college, one or more types and named entities, device type using, and one or more types of attributes of user based on profile of users specific users.

Google™ Keyword Planner™ enables to research keywords to help finding keywords to add to a new campaign or, maybe want to find additional keywords to add to an existing campaign. Advertiser can search for keyword and ad groups ideas based on terms that are relevant to their product or service, landing page, or different product categories. Get historical statistics and traffic forecasts. Use statistics like search volume to help advertiser decide which keywords to use for a new or existing campaign. Get forecasts, like predicted clicks and estimated conversions, to get an idea of how a list of keywords might perform for a given bid and budget. These forecasts can also help guide your decision on which bids and budgets to set.

Google™ news feed is a personalized stream of articles, videos, and other content. The feed will appear in its app for Android and iOS, simply called Google. The feed, which includes items drawn from user's search history and topics user choose to follow, is designed to turn Google's app into a destination for browsing as well as search. But Google™ does not enable advertiser to send post or one or more types of contents to advertiser selected or entered keyword(s) and similar keywords associated past or current searching users, who searched contents in search engine based on said selected or entered keyword(s) and similar keywords and further filter based on target criteria provided by advertiser.

Currently RSS feeds enables user to follow one or more sources or websites or webpages of contents or updated contents, so user can receive each posted contents from said followed sources. At present Twitter™ and Facebook™ Like and Follow enables users to follow one or more users of network and receive each posted contents from said followed users. At present Twitter™ and Facebook™ enables advertiser to post advertisement(s) so users of network can follow said advertiser or web page or page or profile of said advertiser including brand, company, product, service, enterprise and entity. User can search and tap on search result item(s) associated like or follow or subscribe button and follow source or user or advertiser or user can follow advertisers or brands from categories lists or user can directly visit webpage or profile page of said advertiser and can tap on like or follow or subscribe button and follow source or user or advertiser to receive each posted content item from said followed source(s) or advertiser(s). Advertisers can pay per follower to accumulate contextual followers.

All prior arts teaches about follow source including user or advertiser or brand or event or hashtag or category or keyword or one or more types of entities from search results or categories lists or web sites or web pages or profile pages by tapping on like or follow or subscribe button to receive each posted content items from followed sources.

At present Facebook™ enables users of network to “Like” post(s) or page(s) or profile page(s), when user “Likes” post(s) or page(s) or profile page(s) by tapping on “Like” button, user is automatically follow or subscribe said post associated user or source or provider of one or more types of content(s) or advertisers or brands. So it will exponentially increases user engagements thus increasing advertisement insertions and advertisement revenues by charging pay per followers, pay per post views. Practically, user can more times taps or clicks on “Like” button” than taps or clicks on “follow” button. So automatically make user, follower of liked post associated source, increases number of followers of said liked post associated source and when said post associated source or advertiser when posts one or more types of content item(s) inkling photo, video, text, link, user actions then post liked users or followers of said source or advertisers receives each post of said advertisers or source. Due to more “Likes” happens and thus more automatically following of sources, user receives more posts from liked post associated sources which makes user feed crowded. Sometimes user forget to unfollow automatically followed sources which leads to increasing of followed sources and thus receiving unnecessary posts from automatically followed sources based on likes of posts.

Facebook™ enables advertisers to boost posts and promoted pages by deliver ads to people based on demographics, interests, and behaviors and custom audiences. Facebook™ enables advertisers to draft and post one or more types of contents or content items including photo, video, text, link, actions including like button, follow button, book, buy, and any combination thereof and post or send or present to all followers of advertisers, wherein advertisers including brand, company, product, service or one or more types of entities, or webpage or profile page of advertisers including brand, company, product, service or one or more types of entities.

Present invention enables users of network to follow or subscribe contents of one or more other users of network by searching users based on user profile and follow search result item associated source(s) or user(s), searching public contents of user and follow search result item(s) associated source(s) or user(s), search, match or select from one or more categories or list of users or sources, visiting profile page or web site or web page of user and tap on follow or subscribe or like button for receiving posted contents from followed source(s). Present invention enables users of network or advertisers to post contents to all or default set or selected or categories or criteria specific or defined followers, wherein defined followers or criteria specific followers including search query specific followers by using wizard or executing structured query language (SQL) or natural query or one or more types of search or matchmaking algorithm, provided criteria specific followers including name, one or more types of identity(ies), age, gender, education, qualification, skill(s), income range(s), interest type(s), language(s), activity type(s), particular or selected or related school(s), college(s) or one or more types of entities, inputted or selected or location(s), place(s), defined or drawn or selected geo-boundaries specific, geo-fence specific, one or more types of attributes or user profile data or filed associated value specific followers. So users or advertisers are enabled to post or send contents to selected or defined followers instead of all followers by default. So users of network or advertisers accumulate followers from network and posting user advertisement posting user is enabling to post contents to targeted or defined criteria specific followers. So followers not get all posts from followed sources instead receive contextual posts from followed users or sources or posting users. Advertiser can determine each message or post specific target criteria for presenting each message or post to contextual followers.

At present when user posts contents then each followers of user receives each post in follower and following features and when user follow other users of network then user receives each post from each followed source, which sometimes creates spam like follow. Now due to various ways to follow, user follows large number of sources of contents which are not contextual for user which creates problem for user to read contextual contents. Present invention enables posting user to post one or more types of contents only to target criteria specific users and/or based on preferences of user, so following user receives contextual contents and does not receive each post from followed source. For example when user follows Amazon™, but user preferences is men's cloth then user will not receive woman's cloth related posts from followed source “Amazon™”. In another example big brand followers are very huge e.g. “Samsung™” releases mobile phone for India then only India region followers will get posts related to said post. In another embodiment present invention enables user to provide preferences and receive preference specific matched messages from followed sources, wherein server matches received messages with preferences of followers of posting user to identify followers as recipient of message and then send said messages to said matched followers instead of sending messages to each followers of posting user which makes contextual feeds for viewing user.

At present Twitter™ and Facebook™ provides feeds wherein user is presented with messages or posts from followers in chronological orders or based on applied one or more algorithms. User can view only latest message or post from followed sources since recent posts presents first in order. So user does not able to view past messages or posts from particular source. In another embodiment present invention enables user to search, match and select sources and add to user timeline or feed or list or search publicly posted contents and add search result item associated source to user timeline or feed or list or visit web page or profile page of brands or products or services or companies or users and add to user timeline or feed or list by tapping on “Add to my timeline or feed” or “Like” or “Add” or “Add me” or “View my updates” or “View my feeds” button or one or more types of controls. After adding source(s) to user's timeline or feed or list of preferred or liked sources, system adds links or tabs of said added or liked sources associated web page in user timeline or feed page or profile page or web page in horizontal or in vertical order, so user can tap on particular tab or link and can view all posts of said link or tab associated source in chronological order. Parent web page of user feed configured to present multiple web pages of followed sources in horizontal or in vertical or any other manner inside said parent webpage of user's feed or timeline, so user can view all posts or messages in chronological order or as per sort order provided by user by tapping on tab and viewing in vertical order or view in horizontal order of messages or posts. Horizontal feeds enables user to view each source associate message in chronological order and user can swipe or scroll left to right or right to left to view messages in chronological order as per sorted order including date& time wise, keyword or hashtag or category wise. Horizontal feeds enables user to tap on tab to view all messages or posts, in chronological order or any other sorted order, of tab associated followed source or added source. User is present with tabs in horizontal or vertical order. In the event of new message posted by followed sources, tabs associated with said newly posted message or post associated sources presented to user in first order, so user can view immediately without need to scrolling tabs.

In another embodiment when user tap on like in presented or searched post or tap on like by visiting or searching pages of users then system creates list of liked posts or pages including web pages or profile pages of each user of network and automatically make follower of said liked posts or pages or sources or users. In an embodiment after creating list of likes of posts or pages and automatically add user to follower of said liked posts or pages associated sources, server receives, from posting user, message or post or one or more types of content item(s) and associated targeting criteria for identifying or selecting or searching or matching followers of posting user; based on said targeting criteria identify, by a computer processor, the followers of the posting user as recipients of the message; and send the message to the targeted followers of the first user. In an embodiment after creating list of likes of posts or pages and automatically add user to follower of said liked posts or pages associated sources, server receives, from user, targeting criteria; storing, by the processor, targeting criteria for identifying or selecting or searching or matching followers of posting user; receive, from posting user, message or post or one or more types of content item(s); based on said targeting criteria identify, by a computer processor, the followers of the posting user as recipients of the message; and send the message to the targeted followers of the first user.

### OBJECT OF THE INVENTION

The principal object of the present invention is to enabling user to like one or more search result items, web page, profile page, web site, and user, wherein server stores identities of users who liked particular identified post(s), search query specific presented search result item(s) or source associated with search result item(s), web page(s), web site(s), profile page(s) and enable advertiser or requesting user or authorized user to access or filter or select from list of users who liked particular identified post(s) or post(s) associated user or source, search query specific presented search result item(s) or source(s) associated with search result item(s), web page(s) or web page(s) associated user(s), profile page(s) associated user(s) and enabling to send one or more post(s) or advertisement post(s) or message(s) or one or more types of content item(s) and enabling to communicating, collaborating, advertising, marketing, promoting, providing offers, engaging, participating, and sharing with them.

The other object of the present invention is to follow users and then receive preferences specific posts or one or more types of contents from followed sources.

The other object of the present invention is to add users to view updates including one or more types of posted contents, status, location(s), current location, and check-in place(s) related to added users in user's feed or timeline in chronological order.

Other important object of present invention is to enabling advertisers to access or filter or select one or more keyword(s) specific searching users' identities or contacts and enable to further filter said keyword(s) specific searching users' identities or contacts based on provided criteria including gender, age range, interest type, location(s) or place(s) or defined or set or selected or drawn on map geo-fence boundaries, income range, related or named or type of entities including school, collage, company and enabling to send one or more post(s) or advertisement post(s) or message(s) or one or more types of content item(s) and enabling to communicating, collaborating, advertising, marketing, promoting, providing offers, engaging, participating, and sharing with them.

Other important object of present invention is to providing interface to advertiser or user to analyze, data mine, employing data analytics, query, filter, search, match, select criteria specific users based on one or more types of user data including user profile, logged or stored or monitored or tracked user related actions, events, transactions, status, places or locations, activities, communications, collaborations, sharing, senses, selections, searches, installations, subscriptions, following, and participations and post or send or present message(s) or post(s) or one or more types of contents in feed(s) or timeline or inbox or web page or profile page or one or more types of interface(s) to said selected users based on target criteria or target audience.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” posted or shared contents & communication and any types of multimedia contents from a device or component includes receiving the shared or posted contents & communication and any types of multimedia contents indirectly, such as when forwarded by one or more other devices or components. Similarly, “sending” shared contents & communication and any types of multimedia contents to a device or component includes sending the shared contents & communication and any types of multimedia contents indirectly, such as when forwarded by one or more other devices or components.

As used herein, the term “client application” refers to an application that runs on a client computing device. A client application may be written in one or more of a variety of languages, such as ‘C’, ‘C++’, ‘C#’, ‘J2ME’, Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Embodiments described herein receiving, from user, message or post or one or more types of content item(s) and associated targeting criteria for identifying or selecting or searching or matching followers of posting user; based on said targeting criteria identifying, by a computer processor, the followers of the posting user as recipients of the message; and sending the message to the targeted followers of the first user.

In another embodiment receiving, from user, targeting criteria; storing, by the processor, targeting criteria for identifying or selecting or searching or matching followers of posting user; receiving, from posting user, message or post or one or more types of content item(s); based on said targeting criteria identifying, by a computer processor, the followers of the posting user as recipients of the message; and sending the message to the targeted followers of the first user.

In an embodiment presenting interface to enabling to draft or update or prepare one or more types of contents or post or message; presenting interface to prepare or select one or more types of targeting criteria; enabling to post or send or update message and targeting criteria.

In an embodiment targeting criteria comprises all or one or more selected followers or categories of followers, default targeting criteria, inputting, updating or selection of one or more types of user attributes, characteristics, profile data or field and associate values, search query, prepare query based on structured query language (SQL) or natural language query, select criteria via step-by-step wizard, wherein targeting criteria includes name, one or more types of identity(ies), demographics, age, gender, education, qualification, skill(s), income range(s), interest type(s), matched user preferences, language(s), activity type(s), behaviours, particular or selected or related school(s), college(s) or one or more types of entities, inputted or selected or location(s), place(s), defined or drawn or selected geo-boundaries specific, geo-fence specific, one or more contacts, type of device(s), one or more types of attributes or user profile data or filed(s) associated value(s).

In an embodiment enabling to provide one or more types of user data, user profile information, preferences and settings; enabling to search, match, select one or more users of network and tap on follow or like or subscribe button or provide search query and select search query specific one or more search result item(s) and tap on follow or like or subscribe button or visit profile page or web page or web site of user and tap on follow or like or subscribe button to follow or subscribe sources for receiving one or more types of posted content items from followed sources; presenting posts from followed sources, determination of presenting of post based on matching user data with target criteria associated with post or posting user or source or provider or sending user.

In an embodiment user data or user profile information including name, age, gender, education, qualification, skills, interests, preferences, income range, home or work location(s), checked-in place(s), related or interacted or connected one or more type of connections, contacts & entities and one or more types of information related to user.

In an embodiment preferences comprises one or more preferences select or set by user for receiving preferences specific messages or posts or one or more types of contents from one or more selected followed sources, wherein preferences comprises preference for one or more or all sources, receive all posts from all or selected followed sources, one or more keywords, key phrases, categories, hashtags, metadata, product or brand or service names, locations, places, language(s), types of activities, types of interests, type(s) of source(s), types of contents including photo, video, text, link, file type, attachments associated user actions and one or more combinations specific receive posts or messages or contents from all or selected followed sources.

In an embodiment the message distribution system comprising: a computer processor; a routing engine executing on the computer processor and configured to: receive, from a first computing device of a first user, a request for joining a follower group of users following a second user; in response to receiving the request for joining, store information about the first user in a data repository for storing follower group information about the follower group of users; receive, from a second computing device of the second user, a message for distribution to one or more unspecified recipients; access target criteria associated with message or second user; identify, based on the stored follower group information and associated targeting criteria, the users in the follower group as recipients of the message; and a transmission engine configured to send the message to each of the targeted criteria specific identified or searched or matched users in the follower group, including the first user.

In an embodiment the message distribution system comprising: a computer processor; a routing engine executing on the computer processor and configured to: receive, from a first computing device of a first user, a like indication; in response to receiving the like indication, store information about the first user in a data repository for storing follower group information about the follower group of users; receive, from a second computing device of the second user, a message for distribution to one or more unspecified recipients; access target criteria associated with message or second user; identify, based on the stored follower group information and associated targeting criteria, the users in the follower group as recipients of the message; and a transmission engine configured to send the message to each of the targeted criteria specific identified or searched or matched users in the follower group, including the first user.

In an embodiment receiving, from a first computing device of a first user, a selection of a plurality of endpoints for receiving messages, wherein the first user is one of a plurality of users who are followers of a second user; storing the selection of the plurality of endpoints in a storage; receiving, from a second computing device of the second user, a message and a targeting criteria, wherein a message for distribution to one or more unspecified recipients based on targeting criteria; accessing second user or message associated targeting criteria; identifying, by a computer processor, the targeting criteria specific followers of the second user as recipients of the message; identifying, in the storage, the plurality of endpoints selected by the first user; and sending the message to the targeting criteria specific followers of the second user, including the first user, wherein the sending includes sending the message to each of the plurality of endpoints selected by the first user.

In an embodiment the second user is one of a plurality of users who are followers of the first user, and wherein the second user receives messages sent to followers of the first user when user data or user profile of second user matched with the targeting criteria provided or set by first user, and wherein the plurality of endpoints comprises e-mail, short messaging service (SMS), and web.

In an embodiment the message sending preferences comprises targeting criteria for sending message, and wherein the method further comprises: making a determination that a targeting criteria matched with data related to followers of posting user for identifying target criteria specific followers for sending message, wherein the sending of the message to the first user is based on the determination.

In an embodiment a message distribution system, comprising: a computer processor; a routing engine executing on the computer processor and configured to: receive, from a first computing device of a first user, a selection of a plurality of endpoints for receiving messages, wherein the first user is one of a plurality of users who are followers of a second user; store the selection of the plurality of endpoints in a data repository; receive, from a second computing device of the second user, a message and a targeting criteria, wherein a message for distribution to one or more unspecified recipients based on targeting criteria; accessing second user or message associated targeting criteria; identify targeting criteria specific followers of the second user as recipients of the message; and identify, in the data repository, the plurality of endpoints selected by the first user; and a transmission engine configured to send the message to the targeting criteria specific followers of the second user, including the first user, wherein the transmission engine sends the message to each of the plurality of endpoints selected by the first user.

In an embodiment the second user is one of a plurality of users who are followers of the first user, and wherein the second user receives messages sent to followers of the first user when user data or user profile of second user matched with the targeting criteria provided or set by first user, and wherein the plurality of endpoints comprises e-mail, short messaging service (SMS), and web.

In an embodiment a non-transitory computer readable medium comprising a plurality of instructions for message distribution, the plurality of instructions comprising functionality to: receive, from a first computing device of a first user, a selection of a plurality of endpoints for receiving messages, wherein the first user is one of a plurality of users who are followers of a second user; store the selection of the plurality of endpoints in a storage; receive, from a second computing device of the second user, a message and a targeting criteria, wherein a message for distribution to one or more unspecified recipients based on targeting criteria; identify targeting criteria specific followers of the second user as recipients of the message; identify, in the storage, the plurality of endpoints selected by the first user; and send the message to the targeting criteria specific followers of the second user, including the first user, wherein the sending includes sending the message to each of the plurality of endpoints selected by first user.

In an embodiment receiving, from a first computing device of a first user, a selection of a plurality of preferences for receiving messages, wherein the first user is one of a plurality of users who are followers of a second user; storing the selection of the plurality of preferences in a storage; receiving, from a second computing device of the second user, a message for distribution to one or more unspecified recipients; identifying, by a computer processor, the followers of the second user and identifying, in the storage, the plurality of preferences selected by the first user; matching the preferences of the first user with message; identifying, by a computer processor, the matched followers of the second user as recipients of the message; and sending the message to the matched followers of the second user.

In an embodiment preferences for receiving messages comprises one or more categories, keywords, key phrases, names, entities type and names, hashtags, interest types, activity types, locations, places, geo-fence or geo-boundaries, supplied objects which matched with message associated photo or image of video in sequences of image based on object recognition.

In an embodiment the plurality of message receipt preferences comprises a preferences provided by user for receiving messages, and wherein the method further comprises: making a determination that a messages posted by followed sources matched with said user provided preferences for receiving messages, wherein the sending of the message to the first user is based on the determination.

In an embodiment the second user is one of a plurality of users who are followers of the first user, and wherein the second user receives messages sent to followers of the first user, if preferences of second user matched with message content.

In an embodiment a message distribution system, comprising: a computer processor; a routing engine executing on the computer processor and configured to: receive, from a first computing device of a first user, a selection of a plurality of preferences for receiving messages, wherein the first user is one of a plurality of users who are followers of a second user; store the selection of the plurality of preferences in a data repository; receive, from a second computing device of the second user, a message for distribution to one or more unspecified recipients; identify the followers of the second user and identify, in the data repository, the plurality of preferences selected by the first user; match the preferences of the first user with message; identify, by a computer processor, the matched followers of the second user as recipients of the message; and a transmission engine configured to send the message to the matched followers of the second user.

In an embodiment preferences for receiving messages comprises one or more categories, keywords, key phrases, names, entities type and names, hashtags, interest types, activity types, locations, places, geo-fence or geo-boundaries, supplied objects which matched with message associated photo or image of video in sequences of image based on object recognition.

In an embodiment the plurality of message receipt preferences comprises a preferences provided by user for receiving messages, and wherein the method further comprises: making a determination that a messages posted by followed sources matched with said user provided preferences for receiving messages, wherein the sending of the message to the first user is based on the determination.

In an embodiment the second user is one of a plurality of users who are followers of the first user, and wherein the second user receives messages sent to followers of the first user, if preferences of second user matched with message content.

In an embodiment a non-transitory computer readable medium comprising a plurality of instructions for message distribution, the plurality of instructions comprising functionality to: receive, from a first computing device of a first user, a selection of a plurality of preferences for receiving messages, wherein the first user is one of a plurality of users who are followers of a second user; store the selection of the plurality of preferences in a storage; receive, from a second computing device of the second user, a message for distribution to one or more unspecified recipients; identify the followers of the second user and identify, in the storage, the plurality of preferences selected by the first user; matching the preferences of the first user with message; identifying, by a computer processor, the matched followers of the second user as recipients of the message; and send the message to the matched followers of the second user.

In an embodiment a message distribution system for distributing messages, the message distribution system comprising: a computer processor; a routing engine executing on the computer processor and configured to: receive, from a first computing device of a first user, a request for joining a follower group of users following a second user; in response to receiving the request for joining, store information about the first user in a data repository for storing follower group information about the follower group of users; receive, from the first computing device of the first user, a selection of a plurality of preferences for receiving messages, the plurality of preferences including; store selection information regarding the selection of the plurality of preferences in the data repository; receive, from a second computing device of the second user, a message for distribution to one or more unspecified recipients; identify, based on the stored follower group information, the users in the follower group and identify, based on the stored selection information, the plurality of preferences selected by the first user; matching the preferences of the first user with message; identifying, by a computer processor, the matched followers of the second user as recipients of the message; and a transmission engine configured to send the message to each of the said identified matched users in the follower group.

In an embodiment enabling user to add one or more other users or sources of content to list of user; presenting tabs or links of web pages of said added users or sources in user's feed page; and in the event of tapping on particular tab or link from said presented tabs or links, presenting all or updated or filtered posts and messages related to said tapped or clicked tab or link associated source or user.

In an embodiment enabling user to add other users of network based on searching of profiles including user names or user identities of users of network and tapping or clicking on search result item associated embedded or integrated or presented button or icon or link or control.

In an embodiment enabling user to add other users of network based on searching of posted contents of users of network by tapping or clicking on search result item associated embedded or integrated or presented button or icon or link or control to add source(s) associated with search contents.

In an embodiment enabling user to add other users of network based on visiting web site or profile page or web page of user(s) and tapping or clicking on profile page or webpage associated embedded or integrated or presented button or icon or link or control.

In an embodiment horizontally presenting of orders of tabs or links related to added or followed sources or users based on date & time of receiving of new messages or posts or updates from added or followed sources.

In an embodiment horizontally presenting of orders of tabs or links related to added or followed sources or users based on preferences of user.

In an embodiment enabling user to add, remove, rearrange, favorite, hide, show, share, order, filter one or more tabs in user's feed.

In an embodiment present number of newly received or unread messages or posts in each presented tab.

In an embodiment enabling user to switch tabs to view all or related or filtered or presented messages or posts related to tab or link associated source or user.

In an embodiment enabling user to add one or more other users or sources of content to list of user; vertically presenting latest messages from added users or sources in chronological order in user's feed page; and horizontally presenting messages in chronological order to enabling user to swipe or scroll left to right or right to left to view messages from particular source or user.

In an embodiment enabling user to add other users of network based on searching of profiles including user names or user identities of users of network and tapping or clicking on search result item associated embedded or integrated or presented button or icon or link or control.

In an embodiment enabling user to add other users of network based on searching of posted contents of users of network by tapping or clicking on search result item associated embedded or integrated or presented button or icon or link or control to add source(s) associated with search contents.

In an embodiment enabling user to add other users of network based on visiting web site or profile page or web page of user(s) and tapping or clicking on profile page or webpage associated embedded or integrated or presented button or icon or link or control.

In an embodiment receiving, from a first computing device of a first user, a selection of a plurality of preferences for receiving messages, wherein the first user is one of a plurality of users who are followers of a second user; storing the selection of the plurality of preferences in a storage; receiving, from a second computing device of the second user, a message and a targeting criteria, wherein a message for distribution to one or more unspecified recipients based on targeting criteria; accessing second user or message associated targeting criteria; identifying, by a computer processor, the followers of the second user and identifying, in the storage, the plurality of preferences selected by the first user and identifying, in the storage, second user or message associated targeting criteria; matching the preferences of the first user with message and associated targeting criteria; identifying, by a computer processor, the matched followers of the second user as recipients of the message; and sending the message to the matched followers of the second user.

In an embodiment preferences for receiving messages comprises one or more categories, keywords, key phrases, names, entities type and names, hashtags, interest types, activity types, locations, places, geo-fence or geo-boundaries, supplied objects which matched with message associated photo or image of video in sequences of image based on object recognition.

In an embodiment targeting criteria comprises all or one or more selected followers or categories of followers, default targeting criteria, inputting, updating or selection of one or more types of user attributes, characteristics, profile data or field and associate values, search query, prepare query based on structured query language (SQL) or natural language query, select criteria via step-by-step wizard, wherein targeting criteria includes name, one or more types of identity(ies), demographics, age, gender, education, qualification, skill(s), income range(s), interest type(s), language(s), activity type(s), behaviours, particular or selected or related school(s), college(s) or one or more types of entities, inputted or selected or location(s), place(s), defined or drawn or selected geo-boundaries specific, geo-fence specific, one or more contacts, one or more types of attributes or user profile data or filed(s) associated value(s).

In an embodiment a message distribution system, comprising: a computer processor; a routing engine executing on the computer processor and configured to: receive, from a first computing device of a first user, a selection of a plurality of preferences for receiving messages, wherein the first user is one of a plurality of users who are followers of a second user; store the selection of the plurality of preferences in a data repository; receive, from a second computing device of the second user, a message and a targeting criteria, wherein a message for distribution to one or more unspecified recipients based on targeting criteria; accessing second user or message associated targeting criteria; identifying, by a computer processor, the followers of the second user and identifying, in the storage, the plurality of preferences selected by the first user and identifying, in the storage, second user or message associated targeting criteria; matching the preferences of the first user with message and associated targeting criteria; identifying, by a computer processor, the matched followers of the second user as recipients of the message; and a transmission engine configured to send the message to the matched followers of the second user.

In an embodiment preferences for receiving messages comprises one or more categories, keywords, key phrases, names, entities type and names, hashtags, interest types, activity types, locations, places, geo-fence or geo-boundaries, supplied objects which matched with message associated photo or image of video in sequences of image based on object recognition.

In an embodiment targeting criteria comprises all or one or more selected followers or categories of followers, default targeting criteria, inputting, updating or selection of one or more types of user attributes, characteristics, profile data or field and associate values, search query, prepare query based on structured query language (SQL) or natural language query, select criteria via step-by-step wizard, wherein targeting criteria includes name, one or more types of identity(ies), demographics, age, gender, education, qualification, skill(s), income range(s), interest type(s), language(s), activity type(s), behaviours, particular or selected or related school(s), college(s) or one or more types of entities, inputted or selected or location(s), place(s), defined or drawn or selected geo-boundaries specific, geo-fence specific, one or more contacts, one or more types of attributes or user profile data or filed(s) associated value(s).

In an embodiment a message distribution system for distributing messages, the message distribution system comprising: a computer processor; a routing engine executing on the computer processor and configured to: receive, from a first computing device of a first user, a request for joining a follower group of users following a second user; in response to receiving the request for joining, store information about the first user in a data repository for storing follower group information about the follower group of users; receive, from the first computing device of the first user, a selection of a plurality of preferences for receiving messages, the plurality of preferences including; store selection information regarding the selection of the plurality of preferences in the data repository; receive, from a second computing device of the second user, a message and a targeting criteria, wherein a message for distribution to one or more unspecified recipients based on targeting criteria; accessing second user or message associated targeting criteria; identify, based on the stored follower group information, the users in the follower group and identify, based on the stored selection information, the plurality of preferences selected by the first user; matching the preferences of the first user with message and associated targeting criteria; identifying, by a computer processor, the matched followers of the second user as recipients of the message; and a transmission engine configured to send the message to each of the said identified matched users in the follower group.

In another embodiment receiving request to access updated timeline of users to whom requesting user added or related to requesting user; identifying users to whom requesting user added or related to requesting user; retrieving one or more types of contents associated with each said identified users to whom requesting user added or related to requesting user; generating web page comprises said retrieved contents of each said identified users to whom requesting user added or related to requesting user, wherein vertically order row for each added user for horizontally present contents and horizontally order each added user specific new or updated contents chronologically; and presenting said generated web page.

In another embodiment enabling to embedding or integrating or associating like control including like button or link or image or icon with one or more types of digital content item(s) or auto generating one or more types of web page(s) or graphical user interface(s) with auto embedding or integrating or associating like control including like button or link or image or icon with one or more types of digital content item(s) including post, message, search result item, list item, web page, profile page, application, one or more types of graphical user interface (GUI); monitoring, and tracking action or indication of like from users of network from plurality of sources; receiving action or indication of like from users of network from plurality of sources; storing identity of user who like and storing identity of digital item to whom user like and associated data and metadata including date & time of like, location where user liked, user profile and one or more types of user related data and storing identity of user or source or provider associated with digital item to whom user like and storing said digital item associated data and metadata including keywords, tags, categories, location, date & time, type of content, source or posting user's details, associated website or web page or application link, recognized object inside photo or video associated identified keywords; receiving request to access criteria specific data related to users who liked; retrieving requested criteria specific data related to users who liked; presenting data related to users who liked; enabling to select all or criteria specific users who liked from presented requested criteria specific data related to users who liked; presenting interface to enabling the posting user or advertiser to preparing and posting a message or post or one or more types of content or digital item(s); enabling to post said prepared message or post or one or more types of content or digital item(s) to said all or selected or criteria specific selected users who liked; receiving said message or post or one or more types of content or digital item(s) and selections of target recipients; sending said message or post or one or more types of content or digital item(s) to selected target recipients including all or selected or criteria specific selected users who liked; and presenting said message or post or one or more types of content or digital item(s) to selected target recipients including all or selected or criteria specific selected users who liked.

In an embodiment In an embodiment criteria comprise one or more types of user attributes and characteristics including age range, gender, skills, education, income range, related entity types including school, college, company, organization and names location(s) including current location, current checked-in place, work or business or home location(s), defined geo-fence and included or excluded locations, language(s), interest type(s), device type(s), provided keywords or categories or tags match with user profile or user data, one or more location(s) or date & time associated with liked users who liked in past or currently advertiser or user selected one or more keywords, categories, types, entities, locations specific contents and any combination thereof.

In another embodiment monitoring, and tracking one or more types of user actions, events, transactions, indications, activities, connection, relations, status, searching, sharing, participations, communication from users of network from plurality of sources; receiving one or more types of user actions, events, transactions, indications, activities, connection, relations, status, searching, sharing, participations, communication from users of network from plurality of sources; logging or storing identity of user who conducted said one or more types of user actions, events, transactions, indications, activities, connection, relations, status, searching, sharing, participations, communication from users of network from plurality of sources, storing identity of digital item from where user conducted one or more types of user actions, events, transactions, indications, activities, connection, relations, status, searching, sharing, participations, communication from users of network from plurality of sources and storing identity of user or source or provider associated with digital item from where user conducted one or more types of user actions, events, transactions, indications, activities, connection, relations, status, searching, sharing, participations, communication from users of network from plurality of sources, storing said digital item associated metadata; receiving request to access criteria specific data related to users who conducted one or more types of user actions, events, transactions, indications, activities, connection, relations, status, searching, sharing, participations, communication from users of network from plurality of sources; retrieving requested criteria specific data related to users who conducted one or more types of user actions, events, transactions, indications, activities, connection, relations, status, searching, sharing, participations, communication from users of network from plurality of sources; presenting data related to users who conducted one or more types of user actions, events, transactions, indications, activities, connection, relations, status, searching, sharing, participations, communication from users of network from plurality of sources; enabling to select all or criteria specific users who conducted one or more types of user actions, events, transactions, indications, activities, connection, relations, status, searching, sharing, participations, communication from users of network from plurality of sources from presented requested criteria specific data related to users who conducted one or more types of user actions, events, transactions, indications, activities, connection, relations, status, searching, sharing, participations, communication from users of network from plurality of sources; presenting interface to enabling the user to preparing and posting a message or post or one or more types of content or digital item(s); enabling to post said prepared message or post or one or more types of content or digital item(s) to said all or selected or criteria specific selected users who conducted one or more types of user actions, events, transactions, indications, activities, connection, relations, status, searching, sharing, participations, communication from users of network from plurality of sources; receiving said message or post or one or more types of content or digital item(s) and selections of target recipients; sending said message or post or one or more types of content or digital item(s) to selected target recipients including all or selected or criteria specific selected users who conducted one or more types of user actions, events, transactions, indications, activities, connection, relations, status, searching, sharing, participations, communication from users of network from plurality of sources; and presenting said message or post or one or more types of content or digital item(s) to selected target recipients including all or selected or criteria specific selected users who conducted one or more types of user actions, events, transactions, indications, activities, connection, relations, status, searching, sharing, participations, communication from users of network from plurality of sources.

In an embodiment storing identity of user who conducted one or more types of actions, storing details about type of action(s) conducted including date & time, location where user conducted particular type of action(s), storing identity of digital item from where user conducted particular type of action(s) and associated data and metadata including date & time conducted particular type of action(s), location where user conducted particular type of action(s), user profile and one or more types of user related data and storing identity of user or source or provider associated with digital item to whom user conducted particular type of action(s) and storing said digital item associated data and metadata including keywords, tags, categories, location, date & time, type of content, source or posting user's details, associated website or web page or application link, recognized object inside photo or video associated identified keywords.

In an embodiment enabling user to register one or more users and providing user identities

In an embodiment system can associates identity with one or more types of digital content item.

In an embodiment storing digital content item associated identity and associated data and metadata

In an embodiment criteria comprise one or more types of user attributes and characteristics including age range, gender, skills, education, income range, related entity types including school, college, company, organization and names location(s) including current location, current checked-in place, work or business or home location(s), defined geo-fence and included or excluded locations, language(s), interest type(s), device type(s), provided keywords or categories or tags match with user profile or user data, one or more location(s) or date & time associated with liked users who liked in past or currently advertiser or user selected one or more keywords, categories, types, entities, locations specific contents and any combination thereof

In an embodiment enabling to embedding or integrating or generating or associating one or more types of controls with one or more types of digital content item(s) for enabling users of network to conducting one or more types of user actions or indications or activities including like, share, refer, bookmark, add to list, watching, listing and favorite, participate in events, provide locations including current location or checked-in place(s), conduct transactions including book, buy, subscribe, and order, connect with user, follow, provide status, search, participate, communicate including send or receive message from plurality of sources.

In another embodiment monitoring, tracking and storing searching user's actions, activities, reactions, transactions, status including identity of searching user, identity of clicked search result item, search request associates search query or keyword(s), date & time, searching user device location, source of search query, search result associate one or more types of user actions and associate details; receiving post and associated target recipients criteria wherein target recipients criteria comprises one or more keyword(s) and similar keyword(s) and target criteria specific users who searched said received keyword(s) and similar keyword(s) specific contents; identify said one or more keyword(s) and similar keyword(s) and target criteria specific related users who searched said received keyword(s) and similar keyword(s) specific contents; and present said post to said each identified user's device.

In an embodiment search result associate one or more types of user actions and associate details comprises click on search result item or advertisement, click on search result item or advertisement associated web site(s) or web page(s), visit search result item or advertisement associated web site(s) or web page(s), buy, like, share, follow, book, get appointment, fill form, make payment, add to list, send or receive messages, spend time on landing website or web page, click inside said search result item or advertisement associated website or web page.

In an embodiment receive request from advertiser or user to provide similar or suggested keywords based on advertiser or user provided keyword and filter criteria including broad match, broad match modify, phrase match, exact match, negative match and auto match.

In an embodiment target criteria comprises one or more types of user attributes and characteristics including age range, gender, skills, education, income range, related entity types including school, college, company, organization and names location(s) including current location, current checked-in place, work or business or home location(s), defined geo-fence and included or excluded locations, language(s), interest type(s), action type(s), device type(s), one or more location(s) or action type(s) or date & time associated with searching users who searched in past or currently advertiser or user selected keyword(s) specific contents and any combination thereof.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, personal digital assistants (e.g., PDAs), laptop computers, printers, digital picture frames, network equipments (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 illustrates an example system for monitoring tracking, storing various types of user actions and enabling advertisers to send post to users who conducted selected one or more types of action and based on target criteria.

FIG. 2 illustrates some examples, according to various embodiment of present system.

FIG. 3-6 illustrates graphical user interface (GUI) for enabling advertiser to target one or more advertised contents.

FIGS. 4, 5 and 7 illustrate graphical user interface, wherein user or advertiser can post content to target criteria specific users who conducted one or more selected types of actions including users who liked said posting user or advertiser posted or advertised contents or users who liked particular type or keyword or category specific contents and user or advertiser can post content to target criteria specific users who searched one or more selected keywords.

FIG. 8 illustrate graphical user interface, wherein user can view post or one or more types of contents received from contacts, connections, advertisers, user conducted one or more types of actions related sources including liked users or sources, added users or sources, followed sources and searched keywords related posts or contents posted by advertisers or users or from 3^{rd} parties websites, applications, databases and servers.

FIG. 9 illustrate graphical user interface for enabling user to provide preferences for receiving preferences specific contents or posts from user conducted one or more types of actions related sources including liked users or sources, added users or sources, followed sources and searched keywords related posts or contents posted by advertisers or users or from 3^{rd} parties websites, applications, databases and servers.

FIG. 10-11 illustrate graphical user interface for enabling user to provide one or more types of user profile or user data or view user profile including general user profile, business profile, job profile or user data including logged activities, actions, events, transactions, status, locations, checked-in places related to user, logged details about user reactions, sharing, communications, participations and collaborations.

FIG. 12 illustrate graphical user interface for enabling user to tap or click tab which associated with added user or sources, for viewing updates or posts or shared one or more types of contents from tab associated added user or source.

FIG. 13 illustrate graphical user interface assigns one row for each added source or user for enabling user to vertically view each added user or source specific all posted contents or posts in chronological order.

FIG. 14 is a block diagram that illustrates a mobile computing device upon which embodiments described herein may be implemented.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF THE DRAWINGS

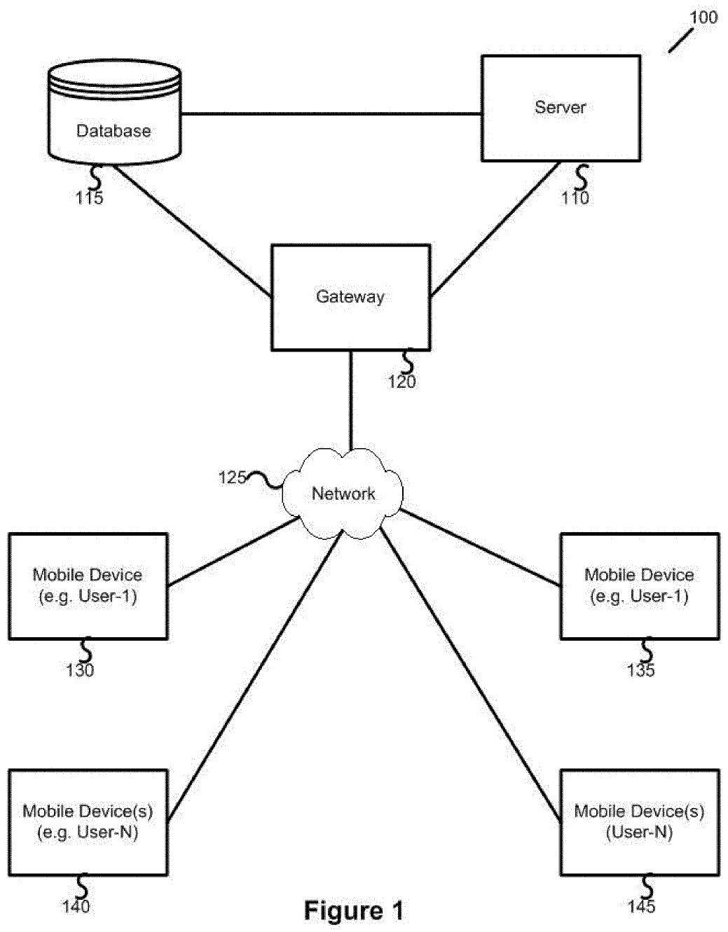

FIG. 1 illustrates platform for targeting user actions specific users for posting contents or communicating users, under an embodiment. According to some embodiments, system 100 can be implemented through software that operates on a portable computing device, such as a mobile computing device 110. System 100 can be configured to monitors, tracks and stores on or more types of user actions, reactions, activities, events, transactions, status, participations, communications, locations from one or more sources including websites, webpages, applications, interfaces, features, search engines, social networks, communication applications, feeds, list of updates and enables advertisers to target audience for presenting advertised one or more types of contents or posts based on selected one or more types of users actions and reactions including like, follow, searched contents based on one or more keywords. Additionally, the mobile computing device can integrate third-party services which enable further functionality through system 100.

The system for enabling users of network to conduct of one or more types of user actions reactions, activities, events, transactions, status, participations, communications, locations from one or more sources including web sites, webpages, applications, interfaces, features, search engines, social networks, communication applications, feeds, list of updates and monitoring, tracking, processing and storing said conducted plurality types of user actions reactions, activities, events, transactions, status, participations, communications, locations from one or more sources including websites, webpages, applications, interfaces, features, search engines, social networks, communication applications, feeds, list of updates and presenting to advertisers interface to enable advertisers to select one or more types of user actions and provide other target criteria to filter users who conducted said selected type specific action(s) and post one or more types of contents to said filtered action type and target criteria specific users of network. While FIG. 1 illustrates a gateway 120, a database 115 and a server 110 as separate entities, the illustration is provided for example purposes only and is not meant to limit the configuration of the targeting user actions specific users for posting contents or communication based system. In some embodiments, gateway 120, database 115 and server 110 may be implemented in the targeting user actions specific users for posting contents or communication based system as separate systems, a single system, or any combination of systems.

As illustrated in FIG. 1, targeting user actions specific users for posting contents or communication based system may include a posting user device or mobile devices 130/140 and viewing user device or mobile devices 135/145. Devices or Mobile devices 130/140/135/145 may be particular set number of or an arbitrary number of devices or mobile devices which may be capable of conducting of one or more types of user actions reactions, activities, events, transactions, status, participations, communications, locations by user(s) from one or more sources including websites, webpages, applications, interfaces, features, search engines, social networks, communication applications, feeds, list of updates and posting target action(s) and criteria specific contents and viewing said contents, searching, selecting and viewing user profile, users, user contents, and one or more types of contents and tap or click on web page or profile page or list item or search result item associated follow or like or add or one or more types of user action(s) button or link or icon or control and posting, sharing, publishing, broadcasting, communicating, advertising, sending, presenting, searching, matching, accessing and managing shared contents. Each device or mobile device in the set of posting user(s) 130/140 and viewing user(s) device or mobile devices 135/140 may be configured to communicate, via a wireless connection, with each one of the other mobile devices 130/140/135/145. Each one of the mobile devices 130/140/135/145 may also be configured to communicate, via a wireless connection, to a network 125, as illustrated in FIG. 1. The wireless connections of mobile devices 130/140/135/145 may be implemented within a wireless network such as a Bluetooth network or a wireless LAN.

As illustrated in FIG. 1, targeting user actions specific users for posting contents or communication based system may include gateway 120. Gateway 120 may be a web gateway which may be configured to communicate with other entities of the targeting user actions specific users for posting contents or communication based system via wired and/or wireless network connections. As illustrated in FIG. 1, gateway 120 may communicate with mobile devices 130/140/135/145 via network 125. In various embodiments, gateway 120 may be connected to network 125 via a wired and/or wireless network connection. As illustrated in FIG. 1, gateway 120 may be connected to database 115 and server 110 of targeting user actions specific users for posting contents or communication based system. In various embodiments, gateway 120 may be connected to database 115 and/or server 110 via a wired or a wireless network connection.

Gateway 120 may be configured to send and receive user actions, user or advertiser posted contents or posts to targeted audience or viewers to/from mobile devices 130/140/135/145. For example, gateway 120 may be configured to receive information about monitored actions of users of network and receive posted contents provided by posting users or publishers or content providers to database 115 for storage.

As another example, gateway 120 may be configured to send or present posted contents to contextual viewers stored in database 115 to mobile devices 130/140/135/145. Gateway 120 may be configured to receive search requests from mobile devices 130/140/135/145 for searching and presenting posted contents.

For example, gateway 120 may receive a request from a mobile device and may query database 115 with the request for searching and matching request specific matched posted contents, and sources for enabling to follow, like and add them. Gateway 120 may be configured to inform server 110 of updated data. For example, gateway 120 may be configured to notify server 110 when a new post has been received from a mobile device or device of posting or publishing or content broadcaster(s) or provider(s) stored on database 115.

As illustrated in FIG. 1, targeting user actions specific users for posting contents or communication based system may include a database, such as database 115. Database 115 may be connected to gateway 120 and server 110 via wired and/or wireless connections. Database 115 may be configured to store a database of registered user's profile, accounts, monitored or tracked user actions and reactions related information, posted or shared contents to target audience received from mobile devices 130/140/135/145 via network 125 and gateway 120.

Database 115 may also be configured to receive and service requests from gateway 120. For example, database 115 may receive, via gateway 120, a request from a mobile device and may service the request by providing, to gateway 120, various types of user actions related information including information about users who liked or follow or add particular source, type(s), category(ies), keyword(s) specific contents , users who searched particular keyword(s), user profile, user data, posted or shared contents, contacts or connections, user or provider account's related data which meet the criteria specified in the request. Database 115 may be configured to communicate with server 110.

As illustrated in FIG. 1, targeting user actions specific users for posting contents or communication based system may include a server, such as server 110. Server may be connected to database 115 and gateway 120 via wired and/or wireless connections. As described above, server 110 may be notified, by gateway 120, of new or updated one or more types of user actions, activities, reactions, status, checked-in place or current location or place, sharing, communication, collaboration, participated events, conducted transactions, senses, user profile, user data, user posted or shared contents stored in database 115.

In another embodiment The system for enabling users of network to conduct of one or more types of user actions reactions, activities, events, transactions, status, participations, communications, locations from one or more sources including websites, webpages, applications, interfaces, features, search engines, social networks, communication applications, feeds, list of updates and monitoring, tracking, processing and storing said conducted plurality types of user actions reactions, activities, events, transactions, status, participations, communications, locations from one or more sources including web sites, webpages, applications, interfaces, features, search engines, social networks, communication applications, feeds, list of updates and presenting to advertisers interface to enable advertisers to select one or more types of user actions and provide other target criteria to filter users who conducted said selected type specific action(s) and post one or more types of contents to said filtered action type and target criteria specific users of network may be referred to herein, for simplicity, as the “targeting user actions specific users for posting contents or communication based system” FIG. 1 illustrates a block diagram of an targeting user actions specific users for posting contents or communication based system configured to implement the platform where user(s) or advertisers can post contents to target user actions specific users or viewers. While FIG. 1 illustrates a gateway 120, a database 115 and a server 110 as separate entities, the illustration is provided for example purposes only and is not meant to limit the configuration of the targeting user actions specific users for posting contents or communication based system. In some embodiments, gateway 120, database 115 and server 110 may be implemented in the posting user contents and broadcasting or advertising user contents to target or contextual users or viewers based system as separate systems, a single system, or any combination of systems.

In another embodiment FIG. 1 illustrates platform for users to user following or adding users to receive updates from added user, under an embodiment. According to some embodiments, system 100 can be implemented through software that operates on a portable computing device, such as a mobile computing device 110. System 100 can be configured to receiving request from user to add one or more users of network for receiving from them one or more types of contents or posts or updates and enabling to post one or more types of contents to followers or users who add posting user. Additionally, the mobile computing device can integrate third-party services which enable further functionality through system 100.

The system for enabling users of network to prepare or draft or update post or one or more types of contents including photo, video, text, link and any combination thereof, user is enabling to search one or more other users of network to select and add them to list of added source of searching user, user is enabled to search other users and content posted by other users of network based on user profile, user posted or shared messages or contents and add them to list of added source of searching user, user is enabled to visit profile pages or business pages of other users or advertisers of network and can add them to list of added source of user, user is enabled to tap on e.g. “Add” button or icon or link or control integrated or embedded with 3^{rd} parties websites, webpages, applications, contents, search result items and categories list items and add them to list of added source of user for receiving each posted contents from said each added sources on user's feed or timeline or list of updates. While FIG. 1 illustrates a gateway 120, a database 115 and a server 110 as separate entities, the illustration is provided for example purposes only and is not meant to limit the configuration of the follow selected users of network for receiving contents from followed sources based system. In some embodiments, gateway 120, database 115 and server 110 may be implemented in the follow selected users of network for receiving contents from followed sources based system as separate systems, a single system, or any combination of systems.

As illustrated in FIG. 1, the follow selected users of network for receiving contents from followed sources based system may include a posting user device or mobile devices 130/140 and viewing user or follower device or mobile devices 135/145. Devices or Mobile devices 130/140/135/145 may be particular set number of or an arbitrary number of devices or mobile devices which may be capable of search, match, select and follow one or more users of network and post contents to followers. Each device or mobile device in the set of posting user(s) 130/140 and viewing user(s) or follower user(s) device or mobile devices 135/140 may be configured to communicate, via a wireless connection, with each one of the other mobile devices 130/140/135/145. Each one of the mobile devices 130/140/135/145 may also be configured to communicate, via a wireless connection, to a network 125, as illustrated in FIG. 1. The wireless connections of mobile devices 130/140/135/145 may be implemented within a wireless network such as a Bluetooth network or a wireless LAN.

As illustrated in FIG. 1, the follow selected users of network for receiving contents from followed sources based system may include gateway 120. Gateway 120 may be a web gateway which may be configured to communicate with other entities of the follow selected users of network for receiving contents from followed sources based system via wired and/or wireless network connections. As illustrated in FIG. 1, gateway 120 may communicate with mobile devices 130/140/135/145 via network 125. In various embodiments, gateway 120 may be connected to network 125 via a wired and/or wireless network connection. As illustrated in FIG. 1, gateway 120 may be connected to database 115 and server 110 of the follow selected users of network for receiving contents from followed sources based system. In various embodiments, gateway 120 may be connected to database 115 and/or server 110 via a wired or a wireless network connection.

Gateway 120 may be configured to receive request to follow other users, post one or more types of contents to followers to/from mobile devices 130/140/135/145. For example, gateway 120 may be configured to receive request to follow other users and receive one or more types of contents to database 115 for storage.

As another example, gateway 120 may be configured to send or present posted contents to followers stored in database 115 to mobile devices 130/140/135/145. Gateway 120 may be configured to receive search requests from mobile devices 130/140/135/145 for searching and presenting posted contents and search sources.

For example, gateway 120 may receive a request from a mobile device and may query database 115 with the request for searching and matching request specific matched posted contents, and sources for enabling to follow and add them. Gateway 120 may be configured to inform server 110 of updated data. For example, gateway 120 may be configured to notify server 110 when a new post has been received from a mobile device or device of posting or publishing or content broadcaster(s) or provider(s) stored on database 115.

As illustrated in FIG. 1, the follow selected users of network for receiving contents from followed sources based system may include a database, such as database 115. Database 115 may be connected to gateway 120 and server 110 via wired and/or wireless connections. Database 115 may be configured to store a database of registered user's profile, accounts, posted contents, followers of each user of network received from mobile devices 130/140/135/145 via network 125 and gateway 120.

Database 115 may also be configured to receive and service requests from gateway 120. For example, database 115 may receive, via gateway 120, a request from a mobile device and may service the request by providing, to gateway 120, followers, user profile, user data, posted or shared contents, contacts or connections, user or provider account's related data which meet the criteria specified in the request. Database 115 may be configured to communicate with server 110.

As illustrated in FIG. 1, the follow selected users of network for receiving contents from followed sources based system may include a server, such as server 110. Server may be connected to database 115 and gateway 120 via wired and/or wireless connections. As described above, server 110 may be notified, by gateway 120, of new or updated followers or following to other users of network, one or more types of user actions, activities, reactions, status, checked-in place or current location or place, sharing, communication, collaboration, participated events, conducted transactions, senses, user profile, user data, user posted or shared contents stored in database 115.

In another embodiment the system for enabling users of network to prepare or draft or update post or one or more types of contents including photo, video, text, link and any combination thereof, user is enabling to search one or more other users of network to select and add them to list of added source of searching user, user is enabled to search other users and content posted by other users of network based on user profile, user posted or shared messages or contents and add them to list of added source of searching user, user is enabled to visit profile pages or business pages of other users or advertisers of network and can add them to list of added source of user, user is enabled to tap on e.g. “Add” button or icon or link or control integrated or embedded with 3^{rd} parties websites, webpages, applications, contents, search result items and categories list items and add them to list of added source of user for receiving each posted contents from said each added sources on user's feed or timeline or list of updates may be referred to herein, for simplicity, as the “the follow selected users of network for receiving contents from followed sources based system” FIG. 1 illustrates a block diagram of the follow selected users of network for receiving contents from followed sources based system configured to implement the platform where users of network can follow any other users of network and can post one or more types of contents which server 110 presents to followers of said posting user. While FIG. 1 illustrates a gateway 120, a database 115 and a server 110 as separate entities, the illustration is provided for example purposes only and is not meant to limit the configuration of the following users of network and post one or more types of contents to followers of posting user based system. In some embodiments, gateway 120, database 115 and server 110 may be implemented in the follow selected users of network for receiving contents from followed sources based system as separate systems, a single system, or any combination of systems.

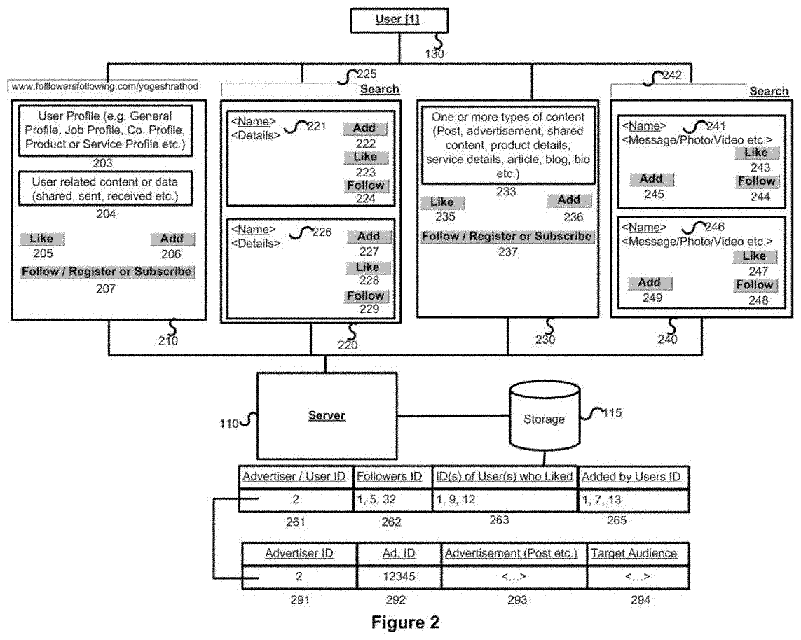

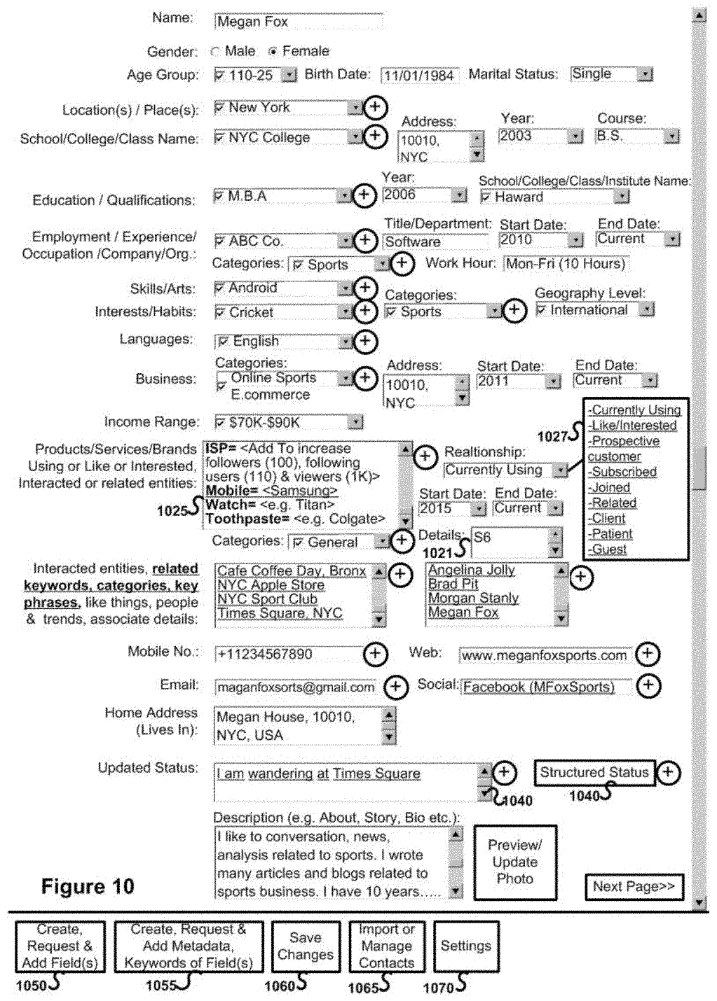

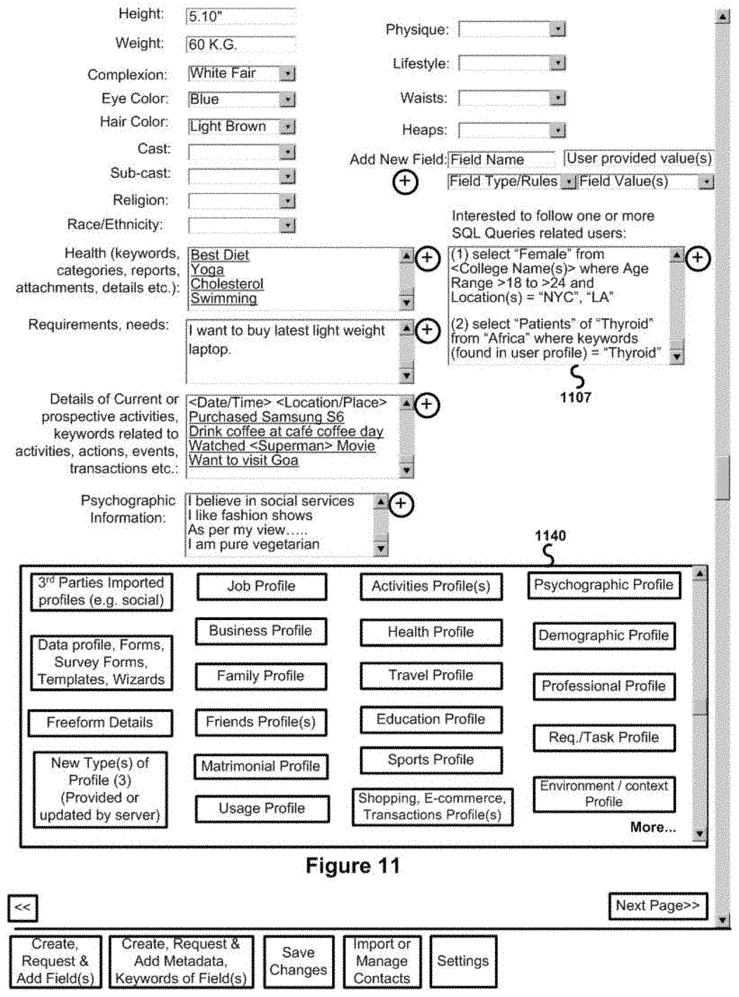

FIG. 2 illustrates various examples of various types of user actions, reactions, interactions, activities, transactions, sharing, searching, communication and participations. For example FIG. 2 illustrates exemplary user [1] 130 interact or conduct one or more actions, activities, reactions, transactions, searching, sharing, participations, communication, collaborations in various ways, for example when user taps or clicks on “Like” button 205 to like particular identified profile page or web page 210 including company page, brand page, product or service page, general user profile and job profile or taps or clicks on “Follow” button 207 to follow said web page or profile page associated user to receive posts or messages send or post by said web page or profile page user or conducting of other one or more types of user action(s) (not shown all actions in figure) by tapping or clicking or selecting or inputting associated one or more controls including button, menu item(s), input box or search query box, radio button, check box, list, combo box for selection e.g. add web page associated source to user's list for receiving updates or posted contents from said web page or user profile or interface associated user (discuss in detail in FIGS. 10 and 11) by tapping or clicking on “Add” button 206, then server 110 monitors, tracks, processes and stores 115 identity of user who conduct action, type of action, identity of source where user conduct action e.g. identity of web page or profile page or brand page associated user. For example when user [1] click on “Like” button associated or embedded or integrated in web page or profile page 210 of user [2] then server 110 stores in database 115, identity of user [1] 263 who liked web page or profile page 210 related or associated with user [2] by tapping or clicking on “Like” button” 205 and stores web page or profile page 210 related or associated user e.g. user [2] 261 in storage medium e.g. relational database 115. In another example when user [1] click on “Follow” button 207 associated or embedded or integrated in web page or profile page 210 of user [2] then server 110 stores in database 115, identity of user [1] 262 who follow or subscribe web page or profile page 210 related or associated with user [2] by tapping or clicking on “Follow” button” 205 and stores web page or profile page 210 related or associated user e.g. user [2] 261 in storage medium e.g. relational database 115.

In another example user [1] 130 searches 225 people or user or one or more types of entities including brand, hashtag, product, service, company name, wherein user is presented with search query specific search result in web page or graphical user interface 220 e.g. search result item 221 and 226 and enabling user 130 to tap or click on said e.g. search result item 221 embedded or associated or integrated “Like” button 223 to like particular or search result item e.g. 221 associated or identified user or source or provider or one or more types of entities including brand, hashtag, product, service, company or tap or click on “Follow button 224 to follow said search result item 221 associated user or provider or source to receive posts or messages or one or more types of contents from said search result item 221 associated user or provider or source.

For example when user [1] click on “Like” button associated or embedded or integrated in search result item 221 then server 110 stores in database 115, identity of user [1] 263 who liked search result item 221 related or associated with user [2] by tapping or clicking on “Like” button” 223 and stores search result item 221 related or associated user e.g. user [2] 261 in storage medium e.g. relational database 115. In another example when user [1] click on “Follow” button 224 associated or embedded or integrated in search result item 221 then server 110 stores in database 115, identity of user [1] 262 who follow or subscribe search result item 221 related or associated with user [2] by tapping or clicking on “Follow” button” 224 and stores search result item 221 related or associated user or source or provider e.g. user [2] 261 in storage medium e.g. relational database 115.

In another example when user taps or clicks on “Like” button 235 associated with post or message or one or more types of contents 233 received or presented or shared contents from one or more sources including contacts, connected users, and followed sources in user's feed or timeline or inbox or web page or profile page or interface 230, then server 110 monitors, tracks, processes and stores 115 identity of user who conduct action, type of action, identity of source where user conduct action e.g. identity of post or shared content associated user or posting user or sender or advertiser identity. For example when user [1] 130 clicks on “Like” button associated or embedded or integrated with Post 233 of user [2] then server 110 stores in database 115, identity of user [1] 263 who liked post 233 related or associated with user [2] 261 by tapping or clicking on “Like” button” 235 and stores post or presented or received content 233 related or associated user e.g. user [2] 261 in storage medium e.g. relational database 115. In another example when user [1] click on “Follow” button 207 associated or embedded or integrated in post or presented or received content 233 of user [2] then server 110 stores in database 115, identity of user [1] 262 who follow or subscribe post or presented or received content 233 related or associated with user [2] by tapping or clicking on “Follow” button” 237 and stores post or presented or received content 233 related or associated user e.g. user [2] 261 in storage medium e.g. relational database 115. User can take one or more types of action(s) from one or more 3^{rd} parties’ web sites, web pages, applications and graphical user interfaces which integrated with or integrate certain functionalities of server 110 by employing application programming Interface (API) and web services.

In another example when user search one or more types of contents by inputting or selecting search query or search keyword(s) 242, then user is presented with search query specific search result comprises one or more types of search query specific searched contents 240, wherein each search result item e.g. 241 is embedded with “Like” button e.g. 243. When searching user e.g. user [1] 130 to taps or clicks on search result item 241 associated “Like” button 243, then server 110 monitors, tracks, processes and stores 115 identity of user who conduct action, type of action, identity of source where user conduct action e.g. identity of post or shared content associated user or posting user or sender or advertiser identity. For example when user [1] 130 clicks on “Like” button 243 associated or embedded or integrated with search result item 241 associated with user [2] then server 110 stores in database 115, identity of user [1] 263 who liked search result item 241 related or associated with user [2] 261 by tapping or clicking on “Like” button” 243 and stores search result item 241 related or associated user e.g. user [2] 261 in storage medium e.g. relational database 115. In another example when user [1] click on “Follow” button 244 associated or embedded or integrated in search result item 241 asscoaited with user [2] then server 110 stores in database 115, identity of user [1] 262 who follow or subscribe post or presented or received content 233 related or associated with user [2] by tapping or clicking on “Follow” button” 244 and stores search result item 241 related or associated user e.g. user [2] 261 in storage medium e.g. relational database 115.

FIG. 2 shows few exemplary user actions of plurality types of user actions. User can take plurality types of actions, reactions, transactions or provides plurality types of actions, reactions, and indications including Like from post, profile page or web page or list item or search result item, Share one or more types of contents, Reply message, Add to wish list one or more products and services, Bookmark or Favorite people, source, web page, web site, products, services, & items, watch video, view or read blog or post, listen music, purchase product, subscribe service, participate in event or group, provide user location & checked-in place to connected users of user, provide particular type of status, search contents, applications, services, products & websites from one or more web sites and applications including social networks, search engines, e-commerce websites, communication applications. Server accumulates or logs or stores various types of user indications, actions, activities, events, transactions, status, reactions, and behaviours. Server 110 creates list of users including user identities, user contacts, user profile, various types of user data based on various types of user indications, reactions, user actions, activities, events, transitions, status, sharing, communications, searching including users who liked or favorite or bookmarked or add to wish list or other type(s) of list particular web page, profile page, brand, user, post, named entity, product, service, item, place, web site, application, one or more types of contents or media including photo and video, category or keyword specific contents, list of users who searches based on particular keywords, list of users who check-in particular place or location, list of users who bought particular product or subscribe service.

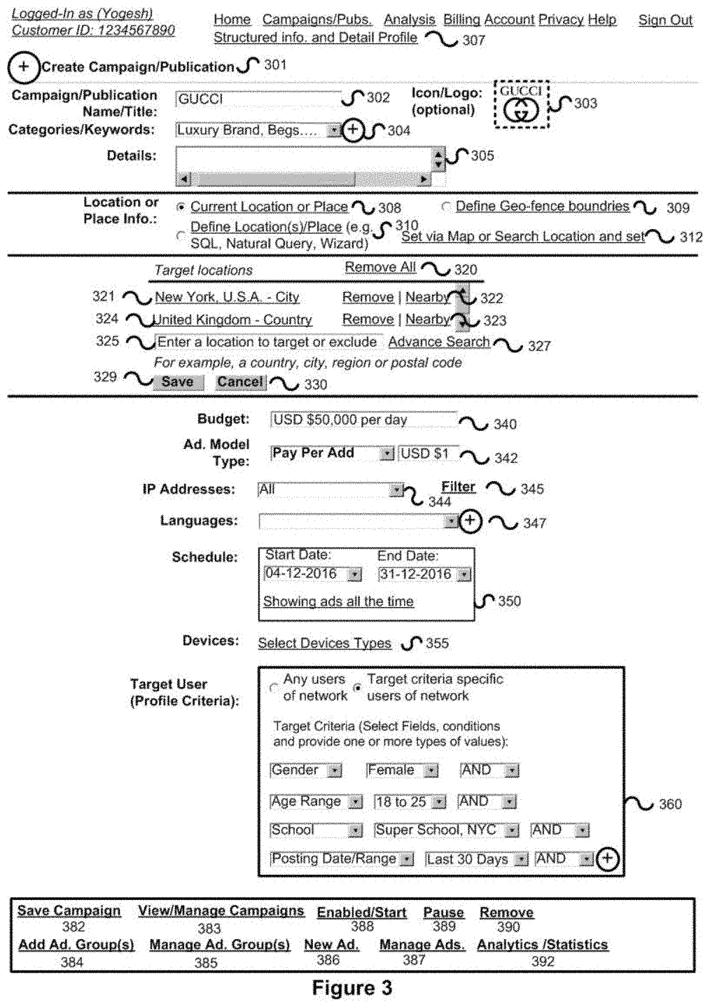

FIG. 3 illustrates exemplary advertisement user interface(s) enabling advertiser or publisher user to create account including provide user and entity details 307 (name, age, gender & other profile information, entity name & address, email, contact information), login information (e.g. user identity or email address, password) billing information & payment information (if paid) or free for general user, authorized publisher and server admin. In an embodiment after creating account, server or system 110 verifies advertiser or publisher or user or account(s) and active user account to enable account holder to create and manage one or more advertisement campaigns, advertisement groups, advertisements and associate target criteria and other settings. In an embodiment enabling advertiser to create one or more advertisement campaigns 301 or enabling user to create one or more publications 301, campaign or publication comprises a set of advertisement groups (advertisements, keywords, and bids) that share a budget, advertisement model type, location targeting, type of user profile or defined characteristics of user targeting, schedules of targeting, languages targeting, device(s) type(s) targeting, campaign types and other settings, campaign settings let advertiser control where and when their advertisements appear and how much they want to spend and campaigns are often used to organize categories of products or services that advertiser offer, Advertiser enable to provide campaign or publication name 302, provide campaign or publication related categories and keywords 304, provide icon or logo or image 303, provide details 305, set or define or provide locations to target advertisement or showing keyword(s) based on matching targeted advertisement related location(s) with current location of user device including select current location as target location 308, select locations or places, provide address, provide geolocation information (e.g., coordinates including latitude, longitude, aptitude) or search or select location(s) or place(s) from/on map 312 or select or define geo-fence boundaries 309 or define types and characteristics of location or query specific locations or places based on structured query language (SQL), natural query and wizard interface, enable to enter (input, auto-fill up, suggested list) location to target or include or exclude location(s) 325, for example user adds locations 321 and 324, remove all added 320, remove selected or find nearby and add 322 or 323, user advance search to provide location criteria, conditions, rules, boundaries, query specific locations or places (For example SQL query: “Select Places where Place Type=‘GUCCI’ or Natural Query” “all GUCCI shops of world”). Advertiser can create separate advertisement campaigns to run advertisements in different locations or using different budgets. Advertiser can provide budget for particular duration including daily maximum spending budget of advertisement 340, daily budget is the amount that advertiser set for each campaign to indicate how much, on average, advertiser's willing to spend per day, advertisement model including pay per add of keyword(s) by users of network 342 or use cost-per-adding of keywords by user in user's collection of keywords (CPA) bidding, which means that advertiser pay only if someone adds advertised keyword(s). In general, the higher the advertiser's bid and the more relevant advertisements and keywords, the more likely advertiser's advertisement will show at a higher position in the suggested list of keywords. Advertiser can provides associated target criteria including add, include or exclude or filter 345 IP addresses 344, one or more languages 347, schedule of showing of advertisement including start date, end date and showing advertisements all the time or particular time, time range at particular date or day 350, select targeted device type(s) 355 including mobile devices, personal computer, wearable device, tablets, android device and/or iOS devices etc., define target user's profile type or characteristics or modeling of target users including any users of network or target criteria specific users of network including one or more types of one or more profile fields including gender, age or age range, education, qualification, home or work locations, related entities including organization or school or college or company name(s) and Boolean operators and any combination thereof 360. After creating and providing information and settings related to created campaign, user or publisher or advertiser can save campaign 382 at server database 115 of server 110 and/or local storage medium of user device 200, so user can access, update, start 388, pause 389, stop or remove 390, view and manage 383 one or more created campaigns and associate information and settings including one or more advertisement groups 384 and 385, and keywords advertisements 386 and 387 and can access started one or more campaigns, advertisement groups and advertisement associated or generated analytics and statistics 392. Advertiser can create and update one or more web pages or profile pages (not shown in FIG. 3) including general profile page, brand specific, product specific, service specific and company specific web page comprises various types of details and advertiser can create one or more types of posts (not shown in FIG. 3) including photo, video, text, slideshow, link and any combination thereof and add one or more types of user actions or call-to-actions including Like, Share, Refer, Message, Chat, Call, Buy, Add to List, Follow, Watch, Listen, Install, Fill Form, Review, Comment, Book, Schedule or Get Appointment. After creating business page or creating advertisement post advertiser can start advertisement campaign, so users of network view said advertisement post(s) and associated web page in prominent place of search results, user's feed or timeline or inbox or profile page or prominent place of one or more features, web pages, web sites and applications based on target criteria. So user can tap or click on advertised post or search result item or web page associated “Like” button or one or more types of user actions or call-to-actions including “Follow”, “Buy”, “Add to Wish List”, “Book”, “Subscribe”, “Call”, “Message” (discuss in detail in FIG. 2) which server 110 monitors, tracks, processes and stores 115 identity of user who conduct action, type of action, identity of source where user conduct action e.g. identity of post or shared content associated user or posting user or sender or advertiser identity.

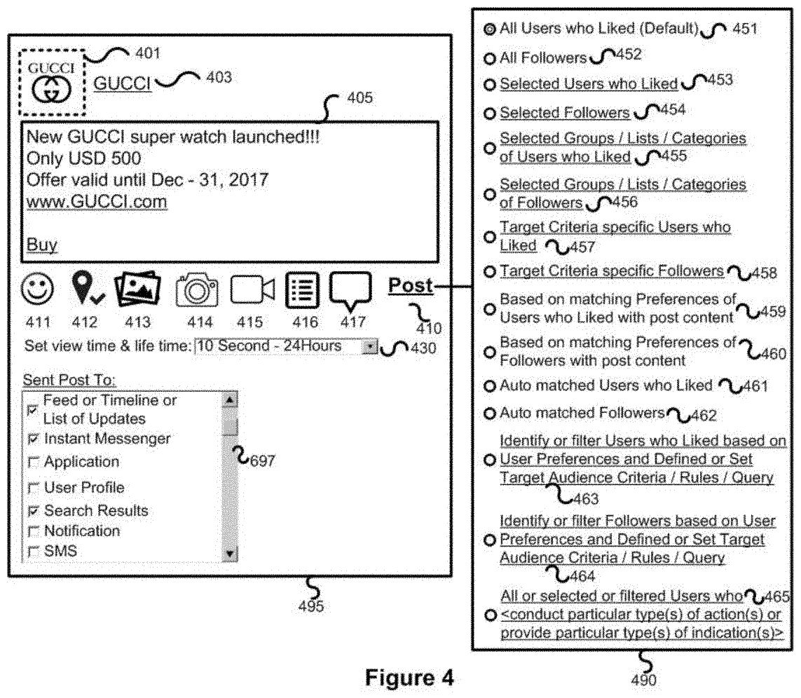

FIG. 4 illustrates graphical user interface (GUI) for enabling advertiser or user 403 to prepare or draft or create or update post or one or more types of contents including select one or more emoticons 411 or geo-stickers or geo-filters, locations or places 412, select one or more photos or videos 413, capture photo 414, record video 415, select contents from list or select structured contents 416, draft or input or select or update text 417, link and any combination thereof. After preparing content, advertiser or user can select one or more options 490 for sending said prepared post 405 by tapping on send or post button 410.

In an embodiment advertiser or user e.g. 261 can select all users who liked e.g. 263 advertiser's web page or profile page e.g. 210 or post(s) 233 or advertisement(s) 233 or shared content(s) 230 or one or more types of digital item(s) by selecting option 451 and can send post 405 to said selected option 451 specific users by tapping or clicking on post or send or broadcast or advertise 410 button, wherein said post e.g. 405/603 presents to feed or timeline or inbox or graphical user interface (GUI) 695 of target recipient(s) device(s).

In an another embodiment advertiser or user e.g. 261 can select all users who followed e.g. 263 advertiser's web page or profile page e.g. 210 or post(s) 233 or advertisement(s) 233 or shared content(s) 230 or one or more types of digital item(s) by selecting option 452 and can send post 405 to said selected option 452 specific users by tapping or clicking on post or send or broadcast or advertise 410 button, wherein said post e.g. 405/603 presents to feed or timeline or inbox or graphical user interface (GUI) 695 of target recipient(s) device(s).

In an embodiment advertiser or user e.g. 261 can select one or more users who liked e.g. 263 advertiser's web page or profile page e.g. 210 or post(s) 233 or advertisement(s) 233 or shared content(s) 230 or one or more types of digital item(s) by selecting option 453 which presents to user list 572 for user selections and can send post 405 to said selected option 453 specific users by tapping or clicking on post or send or broadcast or advertise 410 button, wherein said post e.g. 405/603 presents to feed or timeline or inbox or graphical user interface (GUI) 695 of target recipient(s) device(s).

In an another embodiment advertiser or user e.g. 261 can select one or more users who followed e.g. 263 advertiser's web page or profile page e.g. 210 or post(s) 233 or advertisement(s) 233 or shared content(s) 230 or one or more types of digital item(s) by selecting option 454 which presents to user list 572 for user selections and after selections advertiser or user can send post 405 to said selected option 454 specific users by tapping or clicking on post or send or broadcast or advertise 410 button, wherein said post e.g. 405/603 presents to feed or timeline or inbox or graphical user interface (GUI) 695 of target recipient(s) device(s).

In an embodiment in the event of selection of Selected Groups/Lists/Categories of Users who Liked option 455, advertiser or user is presented with user created or auto generated and updated list(s) 575, wherein list(s) comprise list of users who liked e.g. 263 advertiser's web page or profile page e.g. 210 or post(s) 233 or advertisement(s) 233 or shared content(s) 230 or one or more types of digital item(s) and based on profile identifies who related to particular school, collage, type and named one or more types of entities, actual customers, prospective customers, mutual friend, location and have particular type of user attributes or characteristics including male or female, particular age range, particular location, particular checked-in place, particular type of activity, interest, skill, education, income range, type of device using & like. After selecting one or more list(s), advertiser or user can said post 405 to selected one or more list(s) 575 associated users. User or advertiser is enabled to search, match, filter lists or selected users in one or more selected list(s). User or advertiser is enabled to create and update one or more groups and add or remove one or more users who liked e.g. 263 advertiser's web page or profile page e.g. 210 or post(s) 233 or advertisement(s) 233 or shared content(s) 230 or one or more types of digital item(s).

In an embodiment in the event of selection of Selected Groups/Lists/Categories of Followers option 456, advertiser or user is presented with user created or auto generated and updated list(s) 575, wherein list(s) comprise list of users who followed e.g. 263 advertiser's web page or profile page e.g. 210 or post(s) 233 or advertisement(s) 233 or shared content(s) 230 or one or more types of digital item(s) and based on profile identifies who related to particular school, collage, type and named one or more types of entities, actual customers, prospective customers, mutual friend, location and have particular type of user attributes or characteristics including male or female, particular age range, particular location, particular checked-in place, particular type of activity, interest, skill, education, income range, type of device using & like. After selecting one or more list(s), advertiser or user can said post 405 to selected one or more list(s) 575 associated users. User or advertiser is enabled to search, match, filter lists or selected users in one or more selected list(s). User or advertiser is enabled to create and update one or more groups and add or remove one or more users who followed e.g. 263 advertiser's web page or profile page e.g. 210 or post(s) 233 or advertisement(s) 233 or shared content(s) 230 or one or more types of digital item(s), wherein said post e.g. 405/603 presents to feed or timeline or inbox or graphical user interface (GUI) 695 of target recipient(s) device(s).

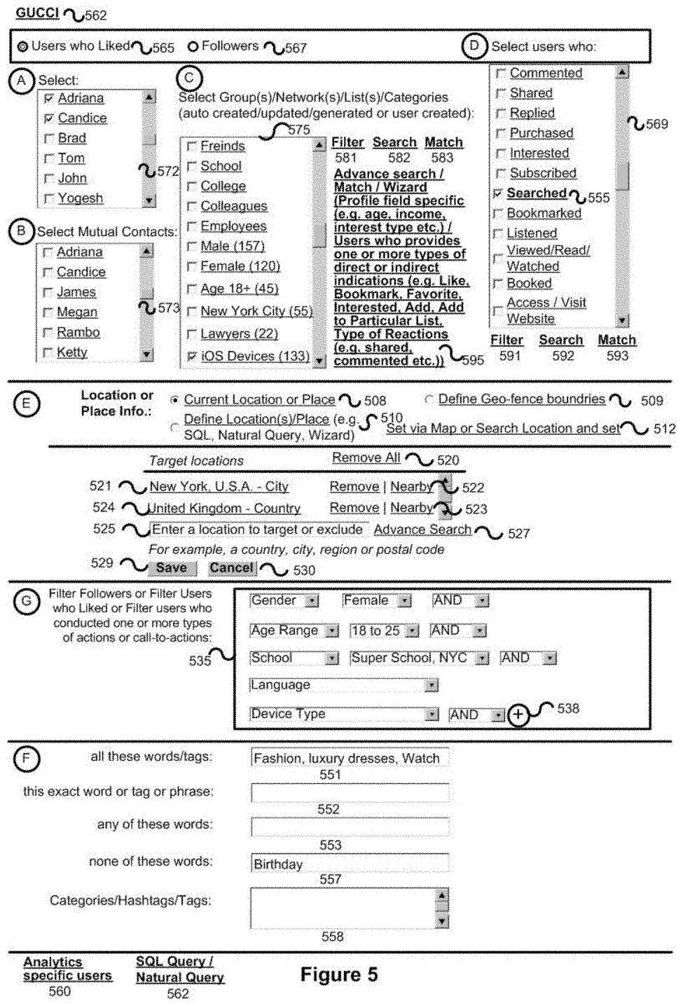

In another embodiment when advertiser or user selects Target Criteria specific Users who Liked option 457 then advertiser or user is presenting with selections or preparing of target criteria interface (FIG. 5), wherein advertiser or user can select one or more target criteria for selection of users who liked e.g. 263 advertiser's web page or profile page e.g. 210 or post(s) 233 or advertisement(s) 233 or shared content(s) 230 or one or more types of digital item(s) including enable to select or set or define or provide locations to target advertisement or posts or one or more types of content items based on matching targeted advertisement related location(s) with current location of user device who liked e.g. 263 advertiser's web page or profile page e.g. 210 or post(s) 233 or advertisement(s) 233 or shared content(s) 230 or one or more types of digital item(s) including select current location as target location 508, select locations or places, provide address, provide geolocation information (e.g., coordinates including latitude, longitude, aptitude) or search or select location(s) or place(s) from/on map 512 or select or define geo-fence boundaries 509 or define types and characteristics of location or query specific locations or places based on structured query language (SQL), natural query and wizard interface, enable to enter (input, auto-fill up, suggested list) location to target or include or exclude location(s) 525, for example user adds locations 521 and 524, remove all added 520, remove selected or find nearby and add 522 or 523, user advance search to provide location criteria, conditions, rules, boundaries, query specific locations or places (For example SQL query: “Select Places where Place Type=‘GUCCI’ or Natural Query” “all GUCCI shops of world”), user or advertiser can target criteria including select targeted device type(s) including mobile devices, personal computer, wearable device, tablets, android device and/or iOS devices etc., define target user's profile type or characteristics or modeling of target users who liked e.g. 263 advertiser's web page or profile page e.g. 210 or post(s) 233 or advertisement(s) 233 or shared content(s) 230 or one or more types of digital item(s) including one or more types of one or more profile fields including gender, age or age range, education, qualification, home or work locations, related entities including organization or school or college or company name(s) and Boolean operators and any combination thereof 538, user or advertiser can select one or more keywords including all these words/tags 551, this exact word or tag or phrase 552, any of these words 553, none of these words 557 and selected one or more categories, Hashtags or Tags 558, which matched with said selected action type e.g. 555 from list of action types 569 associated one or more keywords, search query categories, ranges, locations, languages, tags, hashtags, and type(s), user or advertiser can select one or more keywords including all these words/tags 551, this exact word or tag or phrase 552, any of these words 553, none of these words 557 and selected one or more categories, Hashtags or Tags 558, which matched with user profiles or one or more types of user data related with users who liked e.g. 263 advertiser's web page or profile page e.g. 210 or post(s) 233 or advertisement(s) 233 or shared content(s) 230 or one or more types of digital item(s). In another embodiment providing interface to advertiser or user to analyze, data mine, employing data analytics 560, structured query language (SQL) or natural query 562, filter, search, match, select criteria (fugue 5) specific users based on one or more types of user data including user profile, logged or stored or monitored or tracked user related actions, events, transactions, status, places or locations, activities, communications, collaborations, sharing, senses, selections, searches, installations, subscriptions, following, and participations and post or send or present message(s) or post(s) or one or more types of contents in feed(s) or timeline or inbox or web page or profile page or one or more types of interface(s) to said selected users based on target criteria or target audience. After defining target criteria advertiser or user can send post 405 to said target criteria specific liked users who liked e.g. 263 advertiser's web page or profile page e.g. 210 or post(s) 233 or advertisement(s) 233 or shared content(s) 230 or one or more types of digital item(s) by tapping or clicking on post or send button 410, wherein said post e.g. 405/603 presents to feed or timeline or inbox or graphical user interface (GUI) 695 of target recipient(s) device(s).

In another embodiment when advertiser or user selects Target Criteria specific Followers option 458 then advertiser or user is presenting with selections or preparing of target criteria interface (FIG. 5), wherein advertiser or user can select one or more target criteria for selection of users who followed e.g. 262 advertiser's web page or profile page e.g. 210 or post(s) 233 or advertisement(s) 233 or shared content(s) 230 or one or more types of digital item(s) including enable to select or set or define or provide locations to target advertisement or posts or one or more types of content items based on matching targeted advertisement related location(s) with current location of user device who followed e.g. 262 advertiser's web page or profile page e.g. 210 or post(s) 233 or advertisement(s) 233 or shared content(s) 230 or one or more types of digital item(s) including select current location as target location 508, select locations or places, provide address, provide geolocation information (e.g., coordinates including latitude, longitude, aptitude) or search or select location(s) or place(s) from/on map 512 or select or define geo-fence boundaries 509 or define types and characteristics of location or query specific locations or places based on structured query language (SQL), natural query and wizard interface, enable to enter (input, auto-fill up, suggested list) location to target or include or exclude location(s) 525, for example user adds locations 521 and 524, remove all added 520, remove selected or find nearby and add 522 or 523, user advance search to provide location criteria, conditions, rules, boundaries, query specific locations or places (For example SQL query: “Select Places where Place Type=‘GUCCI’ or Natural Query” “all GUCCI shops of world”), user or advertiser can target criteria including select targeted device type(s) including mobile devices, personal computer, wearable device, tablets, android device and/or iOS devices etc., define target user's profile type or characteristics or modeling of target users who followed e.g. 262 advertiser's web page or profile page e.g. 210 or post(s) 233 or advertisement(s) 233 or shared content(s) 230 or one or more types of digital item(s) including one or more types of one or more profile fields including gender, age or age range, education, qualification, home or work locations, related entities including organization or school or college or company name(s) and Boolean operators and any combination thereof 538, user or advertiser can select one or more keywords including all these words/tags 551, this exact word or tag or phrase 552, any of these words 553, none of these words 557 and selected one or more categories, Hashtags or Tags 558, which matched with said selected action type e.g. 555 from list of action types 569 associated one or more keywords, search query categories, ranges, locations, languages, tags, hashtags, and type(s), user or advertiser can select one or more keywords including all these words/tags 551, this exact word or tag or phrase 552, any of these words 553, none of these words 557 and selected one or more categories, Hashtags or Tags 558, which matched with user profiles or one or more types of user data related with users who followed e.g. 262 advertiser's web page or profile page e.g. 210 or post(s) 233 or advertisement(s) 233 or shared content(s) 230 or one or more types of digital item(s). After defining target criteria advertiser or user can send post 405 to said target criteria specific followed users who followed e.g. 262 advertiser's web page or profile page e.g. 210 or post(s) 233 or advertisement(s) 233 or shared content(s) 230 or one or more types of digital item(s) by tapping or clicking on post or send button 410, wherein said post e.g. 405/603 presents to feed or timeline or inbox or graphical user interface (GUI) 695 of target recipient(s) device(s).

In another embodiment advertiser or user can select option 459 to send post or content 405 to liked users who liked e.g. 262 advertiser's web page or profile page e.g. 210 or post(s) 233 or advertisement(s) 233 or shared content(s) 230 or one or more types of digital item(s) whose preferences matched with type(s) of posts, post associated keywords, categories, location and metadata.

In another embodiment advertiser or user can select option 460 to send post or content 405 to followed users who followed e.g. 262 advertiser's web page or profile page e.g. 210 or post(s) 233 or advertisement(s) 233 or shared content(s) 230 or one or more types of digital item(s) whose preferences matched with type(s) of posts, post associated keywords, categories, location and metadata.

In another embodiment advertiser or user can select option 461 to send post or content 405 to liked users who liked e.g. 262 advertiser's web page or profile page e.g. 210 or post(s) 233 or advertisement(s) 233 or shared content(s) 230 or one or more types of digital item(s) whose preferences and/or settings and/or profile and/or one or more types of user data including current status, current location, checked-in place(s), activities, actions, transactions, participated events matched with type(s) of posts, post associated keywords, categories, location and metadata.

In another embodiment advertiser or user can select option 462 to send post or content 405 to followed users who followed e.g. 262 advertiser's web page or profile page e.g. 210 or post(s) 233 or advertisement(s) 233 or shared content(s) 230 or one or more types of digital item(s) whose preferences and/or settings and/or profile and/or one or more types of user data including current status, current location, checked-in place(s), activities, actions, transactions, participated events matched with type(s) of posts, post associated keywords, categories, location and metadata.

In another embodiment advertiser or user can select option 463 to send post or content 405 to target criteria specific users who liked e.g. 262 advertiser's web page or profile page e.g. 210 or post(s) 233 or advertisement(s) 233 or shared content(s) 230 or one or more types of digital item(s) as discussed in 457, wherein server 110 further filter target recipients by matching preferences of users with post associated keywords, tags, categories and then send to them.

In another embodiment advertiser or user can select option 464 to send post or content 405 to target criteria specific users who followed e.g. 262 advertiser's web page or profile page e.g. 210 or post(s) 233 or advertisement(s) 233 or shared content(s) 230 or one or more types of digital item(s) as discussed in 458, wherein server 110 further filter target recipients by matching preferences of users with post associated keywords, tags, categories and then send to them.

In an embodiment server 110 enables user to register with server 110, wherein server provides and stores unique identity to register user. Users of network or 3^{rd} parties websites, applications, developers, providers and users are enabling to embedding or integrating or generating or associating one or more types of controls with one or more types of digital content item(s) for enabling users of network to conducting one or more types of user actions or indications or activities from one or more sources, websites, webpages and applications, wherein user actions or indications or activities including like, share, refer, bookmark, add to list, watching, listing and favorite, participate in events, provide locations including current location or checked-in place(s), conduct transactions including book, buy, subscribe, and order, connect with user, follow, provide status, search, participate, communicate including send or receive message from plurality of sources. In an embodiment server 110 provides and stores unique identity to one or more types of said digital content item(s). In an embodiment server 110 stores data and metadata with said one or more types of said digital content item(s).

In an embodiment server 110 monitors and tracks one or more types of user actions, events, transactions, indications, activities, connection, relations, status, searching, sharing, participations, communication from users of network from plurality of sources and server 110 logs and stores identity of user who conducted said one or more types of user actions, events, transactions, indications, activities, connection, relations, status, searching, sharing, participations, communication from plurality of sources, stored identity of digital item from where user conducted one or more types of user actions, events, transactions, indications, activities, connection, relations, status, searching, sharing, participations, communication from users of network from plurality of sources and stores identity of user or source or provider associated with digital item from where user conducted one or more types of user actions, events, transactions, indications, activities, connection, relations, status, searching, sharing, participations, communication from users of network from plurality of sources, and stores said digital item associated metadata. Server 110 receives request to access criteria specific data related to users who conducted one or more types of user actions, events, transactions, indications, activities, connection, relations, status, searching, sharing, participations, communication from plurality of sources e.g. by tapping or clicking on option 465 and retrieves from storage medium 115 requested criteria specific data related to users who conducted one or more types of user actions, events, transactions, indications, activities, connection, relations, status, searching, sharing, participations, communication from plurality of sources at user interface e.g. interface 569 wherein advertiser or user can select one or more types of actions, search, match and filter associated users. Server 110 presents data related to users who conducted one or more types of user actions, events, transactions, indications, activities, connection, relations, status, searching, sharing, participations, communication from plurality of sources to requesting user device and enables to select all or criteria specific users who conducted one or more types of user actions, events, transactions, indications, activities, connection, relations, status, searching, sharing, participations, communication from plurality of sources from presented requested criteria specific data. Based on request server 110 presents interface to enabling the user to preparing and posting a message or post or one or more types of content or digital item(s) and enables to post said prepared message or post or one or more types of content or digital item(s) to said all or selected or criteria specific selected users who conducted one or more types of user actions, events, transactions, indications, activities, connection, relations, status, searching, sharing, participations, communication from plurality of sources. Server 110 receives said message or post or one or more types of content or digital item(s) 405 and selections of target recipients and sends said message or post or one or more types of content or digital item(s) to selected target recipients including all or selected or criteria specific selected users who conducted one or more types of user actions, events, transactions, indications, activities, connection, relations, status, searching, sharing, participations, communication from plurality of sources and presents said message or post or one or more types of content or digital item(s) to selected target recipients including all or selected or criteria specific selected users who conducted one or more types of user actions, events, transactions, indications, activities, connection, relations, status, searching, sharing, participations, communication from plurality of sources, wherein advertiser or user can select one or more target criteria for selection of users who conducted one or more selected or searched 592 or filtered 591 or matched 593 one or more types of actions 569 e.g. users who conducted one or more types of provided actions from e.g. 262 advertiser's web page or profile page e.g. 210 or post(s) 233 or advertisement(s) 233 or shared content(s) 230 or one or more types of digital item(s) including enable to select or set or define or provide locations to target advertisement or posts or one or more types of content items based on matching targeted advertisement related location(s) with current location of user devices who conducted one or more types of provided actions from e.g. 262 advertiser's web page or profile page e.g. 210 or post(s) 233 or advertisement(s) 233 or shared content(s) 230 or one or more types of digital item(s) including select current location as target location 508, select locations or places, provide address, provide geolocation information (e.g., coordinates including latitude, longitude, aptitude) or search or select location(s) or place(s) from/on map 512 or select or define geo-fence boundaries 509 or define types and characteristics of location or query specific locations or places based on structured query language (SQL), natural query and wizard interface, enable to enter (input, auto-fill up, suggested list) location to target or include or exclude location(s) 525, for example user adds locations 521 and 524, remove all added 520, remove selected or find nearby and add 522 or 523, user advance search to provide location criteria, conditions, rules, boundaries, query specific locations or places (For example SQL query: “Select Places where Place Type=‘GUCCI’ or Natural Query” “all GUCCI shops of world”), user or advertiser can target criteria including select targeted device type(s) including mobile devices, personal computer, wearable device, tablets, android device and/or iOS devices etc., define target user's profile type or characteristics or modeling of target users who conducted one or more types of provided actions from e.g. 262 advertiser's web page or profile page e.g. 210 or post(s) 233 or advertisement(s) 233 or shared content(s) 230 or one or more types of digital item(s) including one or more types of one or more profile fields including gender, age or age range, education, qualification, home or work locations, related entities including organization or school or college or company name(s) and Boolean operators and any combination thereof 538, user or advertiser can select one or more keywords including all these words/tags 551, this exact word or tag or phrase 552, any of these words 553, none of these words 557 and selected one or more categories, Hashtags or Tags 558, which matched with said selected action type e.g. 555 from list of action types 569 associated one or more keywords, search query categories, ranges, locations, languages, tags, hashtags, and type(s), user or advertiser can select one or more keywords including all these words/tags 551, this exact word or tag or phrase 552, any of these words 553, none of these words 557 and selected one or more categories, Hashtags or Tags 558, which matched with user profiles or one or more types of user data related with users who conducted one or more types of provided actions from e.g. 262 advertiser's web page or profile page e.g. 210 or post(s) 233 or advertisement(s) 233 or shared content(s) 230 or one or more types of digital item(s). After defining target criteria advertiser or user can send post 405 to said target criteria specific users who conducted one or more types of provided actions from e.g. 262 advertiser's web page or profile page e.g. 210 or post(s) 233 or advertisement(s) 233 or shared content(s) 230 or one or more types of digital item(s) by tapping or clicking on post or send button 410, wherein said post e.g. 603 presents to feed or timeline or inbox or graphical user interface (GUI) 695 of target recipient(s) device(s). In another embodiment providing interface to advertiser or user to analyze, data mine, employing data analytics 560, structured query language (SQL) or natural query 562, filter, search, match, select criteria (fugue 5) specific users based on one or more types of user data including user profile, logged or stored or monitored or tracked user related actions, events, transactions, status, places or locations, activities, communications, collaborations, sharing, senses, selections, searches, installations, subscriptions, following, and participations and post or send or present message(s) or post(s) or one or more types of contents in feed(s) or timeline or inbox or web page or profile page or one or more types of interface(s) to said selected users based on target criteria or target audience.

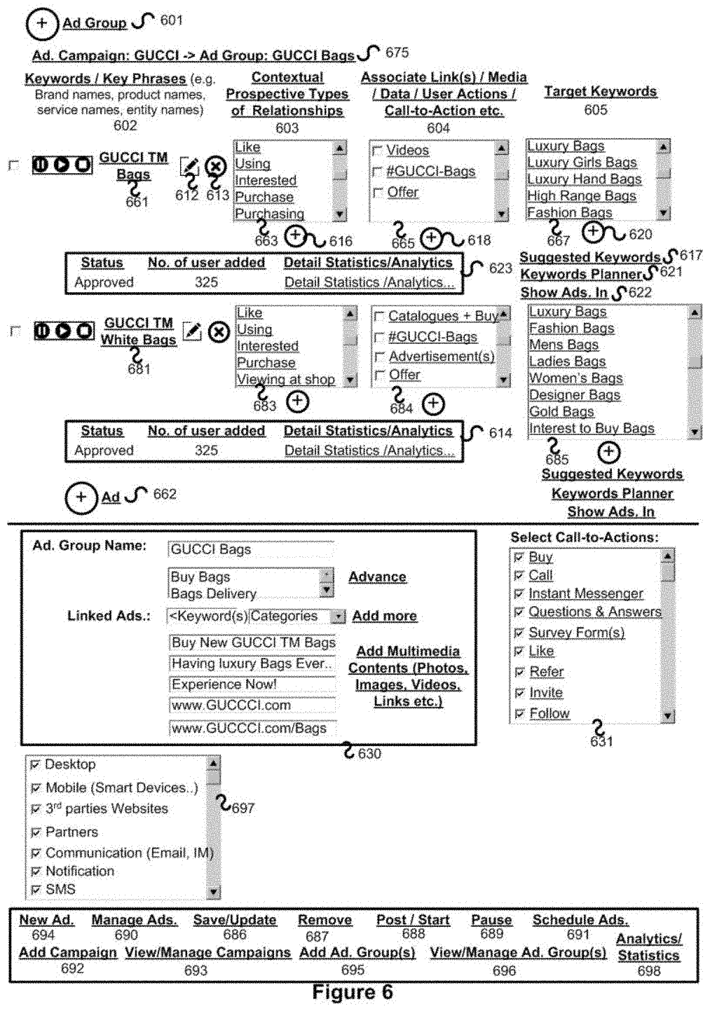

In another embodiment FIG. 3 illustrates exemplary advertisement user interface(s) enabling advertiser or publisher user to create account including provide user and entity details 307 (name, age, gender & other profile information, entity name & address, email, contact information), login information (e.g. user identity or email address, password) billing information & payment information (if paid) or free for general user, authorized publisher and server admin. In an embodiment after creating account, server or system 110 verifies advertiser or publisher or user or account(s) and active user account to enable account holder to create and manage one or more advertisement campaigns, advertisement groups, advertisements and associate target criteria and other settings. In an embodiment enabling advertiser to create one or more advertisement campaigns 301 or enabling user to create one or more publications 301, campaign or publication comprises a set of advertisement groups (advertisements, keywords, and bids) that share a budget, advertisement model type, location targeting, type of user profile or defined characteristics of user targeting, schedules of targeting, languages targeting, device(s) type(s) targeting, campaign types and other settings, campaign settings let advertiser control where and when their advertisements appear and how much they want to spend and campaigns are often used to organize categories of products or services that advertiser offer, Advertiser enable to provide campaign or publication name 302, provide campaign or publication related categories and keywords 304, provide icon or logo or image 303, provide details 305, set or define or provide locations to target advertisement or showing keyword(s) based on matching targeted advertisement related location(s) with current location of user device including select current location as target location 308, select locations or places, provide address, provide geolocation information (e.g., coordinates including latitude, longitude, aptitude) or search or select location(s) or place(s) from/on map 312 or select or define geo-fence boundaries 309 or define types and characteristics of location or query specific locations or places based on structured query language (SQL), natural query and wizard interface, enable to enter (input, auto-fill up, suggested list) location to target or include or exclude location(s) 325, for example user adds locations 321 and 324, remove all added 320, remove selected or find nearby and add 322 or 323, user advance search to provide location criteria, conditions, rules, boundaries, query specific locations or places (For example SQL query: “Select Places where Place Type=‘GUCCI’ or Natural Query” “all GUCCI shops of world”). Advertiser can create separate advertisement campaigns to run advertisements in different locations or using different budgets. Advertiser can provide budget for particular duration including daily maximum spending budget of advertisement 340, daily budget is the amount that advertiser set for each campaign to indicate how much, on average, advertiser's willing to spend per day, advertisement model including pay per add of keyword(s) by users of network 342 or use cost-per-adding of keywords by user in user's collection of keywords (CPA) bidding, which means that advertiser pay only if someone adds advertised keyword(s). In general, the higher the advertiser's bid and the more relevant advertisements and keywords, the more likely advertiser's advertisement will show at a higher position in the suggested list of keywords. Advertiser can provides associated target criteria including add, include or exclude or filter 345 IP addresses 344, one or more languages 347, schedule of showing of advertisement including start date, end date and showing advertisements all the time or particular time, time range at particular date or day 350, select targeted device type(s) 355 including mobile devices, personal computer, wearable device, tablets, android device and/or iOS devices etc., define target user's profile type or characteristics or modeling of target users including any users of network or target criteria specific users of network including one or more types of one or more profile fields including gender, age or age range, education, qualification, home or work locations, related entities including organization or school or college or company name(s) and Boolean operators and any combination thereof 360. After creating and providing information and settings related to created campaign, user or publisher or advertiser can save campaign 382 at server database 115 of server 110 and/or local storage medium of user device 130, so user can access, update, start 388, pause 389, stop or remove 390, view and manage 383 one or more created campaigns and associate information and settings including one or more advertisement groups 384 and 385, and keywords advertisements 386 and 387 and can access started one or more campaigns, advertisement groups and advertisement associated or generated analytics and statistics 392. Advertiser can create and update one or more web pages or profile pages (not shown in FIG. 3) including general profile page, brand specific, product specific, service specific and company specific web page comprises various types of details and advertiser can create one or more types of posts (not shown in FIG. 3) including photo, video, text, slideshow, link and any combination thereof and add one or more types of user actions or call-to-actions 631 including Like, Share, Refer, Message, Chat, Call, Buy, Add to List, Follow, Watch, Listen, Install, Fill Form, Review, Comment, Book, Schedule or Get Appointment. After creating business page or creating advertisement post advertiser can start advertisement campaign, so users of network view said advertisement post(s) and associated web page in prominent place of search results, user's feed or timeline or inbox or profile page or prominent place of one or more features, type of device including mobile, tablet, laptop, desktop, web pages, web sites and applications 697 based on target criteria. So user can tap or click on advertised post or search result item or web page associated “Like” button or one or more types of user actions or call-to-actions including “Follow”, “Buy”, “Add to Wish List”, “Book”, “Subscribe”, “Call”, “Message” (discuss in detail in FIG. 2) which server 110 monitors, tracks, processes and stores 115 identity of user who conduct action, type of action, identity of source where user conduct action e.g. identity of post or shared content associated user or posting user or sender or advertiser identity. FIG. 6 illustrates continues user interface describe in FIG. 3 for enabling advertiser or publisher to create one or more advertisement groups 675 related to particular or selected campaign 302. After creating and set-up of campaign 302 (as discussed in FIG. 3), advertiser can create advertisement group e.g. 670 via clicking or tapping on ad group button 601. An ad group contains one or more ads 661 and 681 which target a shared or different set of keywords and have ads defined by advertiser, wherein ad comprises ad group, keywords, description, call-to actions 631, website or webpage link(s) and one or more types of contents 630. Each of advertiser's or publisher's campaigns (discussed in FIG. 3) is made up of one or more ad groups 675. Advertiser can use ad groups to organize ads by a common theme and use different ad groups for different product or service types. For example, GUCCI™ creates campaign GUCCI™ (discussed in FIG. 3) and creates ad groups 675 including one GUCCI™ bags. After creating ad group e.g. 640 (“GUCCI™ Bags”), advertiser can creates advertisement(s) via create advertisement icon or link or control or button 662. Ad group is where advertiser will add 662, edit 612, remove 613 advertised keywords e.g. 661 (“GUCCI™”), add, edit, remove 663 one or more contextual prospective types of relationships, reactions, activities & actions 663, add, edit, remove 618 one or more call-to-actions or user actions links & controls, applications or links of applications, one or more types of media items or links of added one or more types of media items, one or more types of offer(s) including discount, redeemable points, coupons, cash backs, free gifts or samples or one or more types of benefits 665 and add, edit, remove 620 or choose keywords 667 from suggested list of keywords 617 or select via keywords planner 621 (which helps to find out best relevant keywords which are found more in user data or user related search query or search keywords or key phrase) that can trigger those ads 661 and/or 681 when someone's (i.e. any users of network) user data (user's one or more types of profile or structured information (fields and provided associated values), logged or stored data related to user's activities, actions, events, transactions, senses, behavior, sharing, communications, collaborations, interactions, status, and current or past or checked-in locations or places) and user's search query related keywords including said advertisement related keyword contains said target keywords 667 that can trigger those ads 661 and/or 681 Every campaign needs at least 1 ad group, and every ad group needs at least 1 ad. In another embodiment advertiser can provide target keywords 667 and select type of match (not shown in figure) including broad match, exact match, phrase match, or negative match, wherein broad match is the default match type and when advertiser use broad match, advertiser's ads automatically run on relevant variations of keywords 667 even if these terms aren't in advertisement related target keyword lists 661. In another embodiment advertiser can search, match, select, view details, purchase (if paid), customize, apply privacy settings & add one or more user actions or call-to-actions, controls, functions, objects, buttons, interfaces, links, contents, applications, web services and forms provided by one or more developers 665.

In another embodiment after creating advertisement or publication campaign(s) 302 (as discussed in FIG. 3), campaign associated advertisement group(s) 675 and advertisement group 675 related advertisement keyword(s) 661, 681, user or publisher or advertiser can anytime save campaign associated advertisement group(s) and associated keywords advertisement(s) at server database 115 of server 110 and/or local storage medium of user device e.g. 130, so user can access, update, start 688, pause 689, stop or remove 687, view and manage 690 one or more created campaigns associated advertisement group(s) and associated keywords advertisement(s and associate information and settings including one or more advertisement groups 640 and 675, and keywords advertisements 661, 681 and can add new ads 694, manage currently created ads 690, add new ad group(s) 695, mange ad group(S) 696, add campaign(s) 692, manage campaign(s) 693 and can access started one or more campaigns, advertisement groups and advertisement associated or generated analytics and statistics 699. In another embodiment system or server 110, first verifies advertisement (keywords, logo, brand, product name, service name, description or details, and advertiser's identities etc.) and then allow or approved or make eligible to start said advertisements. In another embodiment advertiser can view, access, and manage each campaign, each ad group of each campaign and each keyword advertisement of each ad group of each campaign related status, statistics and analytics 622.

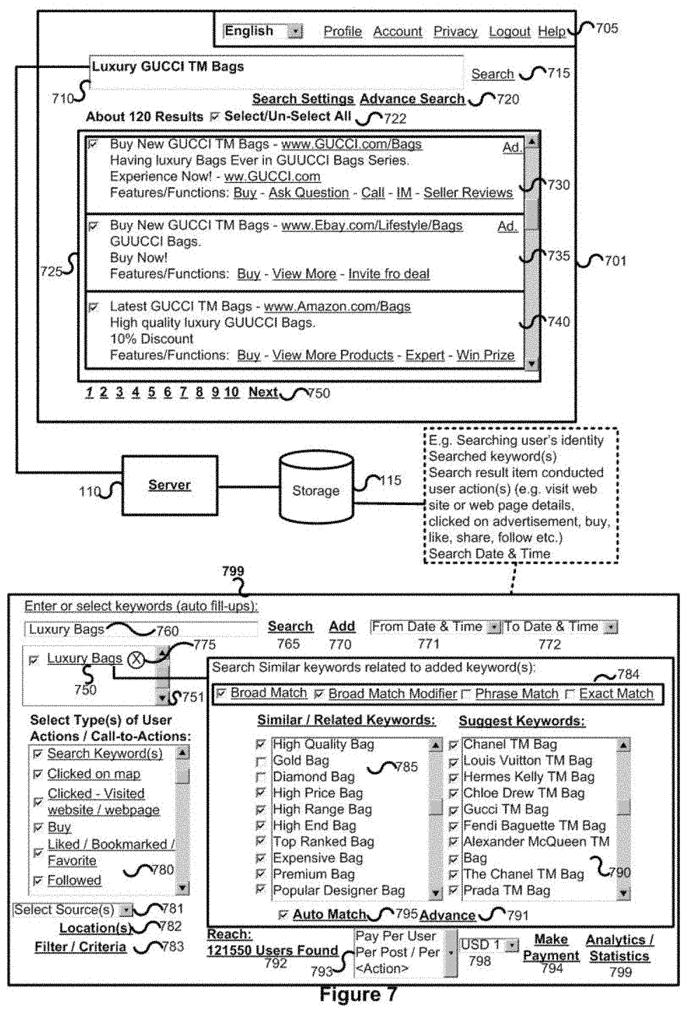

FIG. 7 (701) illustrates graphical user interface (GUI) wherein user can enter or select or update one or more search keywords, key phrases or user search string or search query in search box 710 for searching one or more types of digital contents by tapping or clicking on search button 715 or enter. Server 110 receives request to search based on provided search query 710 and retrieves and processes search query specific data or contents or search for information on the World Wide Web. Based on said retrieved data or contents or information, server 110 generates and presents the search results 725, wherein search results are generally presented in a line of results 725 (730/735/740) often referred to as search engine results pages (SERPs) 750. The information may be a mix of web pages, images, and other types of files. A search engine results page (SERP) 725 is the page displayed by a web search engine 110 in response to a query 710 by a searcher. The main component of the SERP is the listing of results 725 (730/735/740) that are returned by the search engine 110 in response to a keyword query 710, although the page may also contain other results such as advertisements 730 and 735. The results are of two general types, organic (i.e., retrieved by the search engine's algorithm) and sponsored (i.e., advertisements). The results are normally ranked by relevance to the query. Each result displayed on the SERP normally includes a title, a link that points to the actual page on the Web and a short description showing where the keywords have matched content within the page for organic results. For sponsored results 730/735, the advertiser chooses what to display based on advertisement comping, advertisement groups and advertisements (discussed in detail in FIGS. 3 and 6). Due to the huge number of items 750 that are available or related to the query 710 there usually are several SERPs 750 in response to a single search query 710 as the search engine 110 or the user's preferences restrict viewing to a subset of results per page 701. Each succeeding page 750 will tend to have lower ranking or lower relevancy results. Search result item may contain app extensions, which allow advertisers to provide a link below the ad text directing users to a mobile or tablet app, call extensions allow advertisers to include a clickable phone number in their ads, location extensions, allow advertisers to show their business address, phone number, and map marker, review extensions—allow advertisers to showcase positive, third-party reviews from reputable sources, sitelinks extensions, allow advertisers to add additional links below their ads, callout extensions, allow advertisers to add additional descriptive text, structured snippet extensions, allow advertisers to add up to two predefined headers (product or service) like brands or degrees, price extensions, allow advertisers to display prices for products or services, click-to-message extensions, allows advertisers to connect with advertisers via SMS apps.

Server 110 monitors, tracks and stores in storage medium 115 searching user's identity, search queries or search keywords, device type including desktop, tablet, laptop & mobile or smart devices and client application type including online, mobile application from which user searched, user actions, activities, transactions including clicks, visiting of particular website(s) or web page(s), click or tap on call-to-action including click or access call, buy, map & direction, review, reply, ratings, comments, share, bookmark or favorite, add to list, follow, listened, watched, viewed, read, fill form, participate, install application, message or chat functions, invite, book, get appointment features or one or more types of user action(s). Server 110 also stores one or more types of user profiles and user data including general profile including age, gender, skills, education, income range, device using, contacts or connections, interest types, preferences, privacy settings, job profile, business profile, logged user's activities, actions, events, transactions, sharing, communications, participations, locations including current location, checked-in place(s), home & work or business address, status (shown in or discussed in FIGS. 10 & 11).

FIG. 7 (799) illustrates graphical user interface (GUI) enabling user or advertiser to search 765 (in an embodiment user is enabled to find or search keywords based on phrase or website or category, providing product or service details, enter or select product or service category, providing landing page link to identify associated keywords, providing targeting details including location(s), language(s), type of keyword filter (broad match, broad match modifier, phrase match, exact match, negative match), Date range (show average monthly viewer related to said added keyword e.g. 750), auto-fill, enter, update one or more keyword(s), tags, categories, hashtags 760 and add to list 750 by taping or clicking on “Add” button 770. After adding one or more keyword(s) 750, user or advertiser can select said added keyword(s) 750 related similar 785 or suggested 790 keyword(s) based on broad match (similar or suggested keywords 785/790 includes any word in said selected or added keyword(s) or key phrase 750, in any order. For example, if user or advertiser use broad match on “luxury bags,” then similar or suggested keywords 785/790 may include “luxury cars,” “fast cars,” or “luxury apartments”), broad match modifier (presents suggested keywords 785/790 based on added keyword(s) or key phrase 750 which contain the modified term (or close variations , but not synonyms), in any order), negative match (suggested keywords 785/790 comprises keywords without the term or added keyword(s) or key phrase 750), phrase match (selected or added keywords 750 in the exact order user or advertiser enter them, but there might be other words either before or after that phrase 750 e.g. if added key phrase 750 was “pet supplies then suggested or similar keyword(s) or key phrase 785/790 may include “pet supplies,” “discount pet supplies,” or “pet supplies wholesale,” but not for searches like “pet food,” “pet bird supplies) and exact match 784 (For example, if keyword phrase 750 was “black cocktail dress,” then suggested or similar keyword(s) or key phrase 785/790 may include “black cocktail dress” (those words in that exact order) and not for “cocktail dress,” “black dress” or “expensive black cocktail dress.”). In an embodiment user can select “Auto Match” option 795 to enable server 110 to auto identify similar or contextual keywords based on matching added keyword(s) or key phrase(s) 750 and post or shared content related keywords with profile or user data of past and current searching user related to said added keyword(s) or key phrase(s) 750, who searched said added keyword(s) or key phrase(s) 750 specific contents. In an embodiment user can select one or more type of actions 780 to filter added keyword(s) or key phrase(s) 750 specific users who searched said added keyword(s) or key phrase(s) 750 specific contents.

Based on said added keyword(s) or key phrase(s) 750 and selected or auto matched or selection of broad match specific or phrase match specific or exact match specific similar types of keyword(s) or key phrase(s) 785/790 by identified or registered user or advertiser, server 110 identifies said added keyword(s) or key phrase(s) 750 specific identified searching users who searched said added keyword(s) or key phrase(s) 750 or similar types of keyword(s) or key phrase(s) 785/790 specific searches e.g. 710 e.g. based on said added keywords 750, server 110, searches or identifies all users who searched said added keywords 750 or identified or selected similar or suggested keywords 785/790 “Luxury bag”, “Luxury bags”, “High Quality Bag”, “High Price Bag”, “High Range Bag”, “High End Bag”, “Top Ranked Bag”, “Expensive Bag”, “Premium Bag”, “Popular Designer Bag”, Chanel™ Bag, “Louis Vuitton™ Bag”, “Hermes Kelly™ Bag”, “Chloe Drew™ Bag”, “Gucci™ Bag”, “Fendi Baguette™ Bag”, “Alexander McQueen™ Bag”, “The Chanel™ Bag”, “Prada™ Bag” specific searching users, who searched said added keywords 750 or identified or selected similar or suggested keywords 785/790 specific contents, from storage medium 115 connected with server 110.

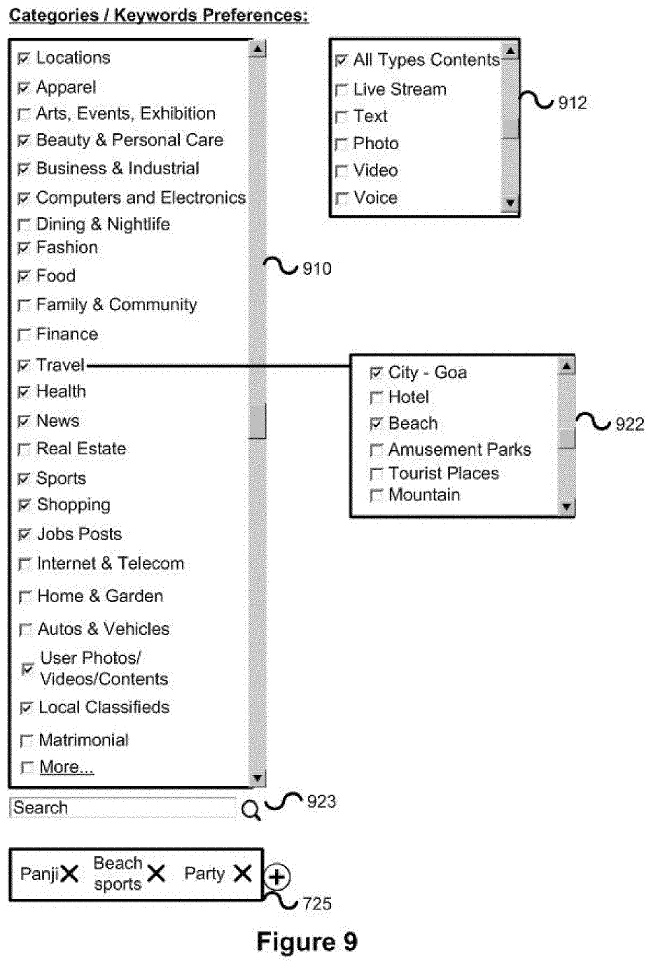

In an embodiment user or advertiser is provided with average monthly viewers, competition level (e.g. High, Medium, Low), average position of post, average cost per click, average cost type(s) of action or call-to-action, and suggested bid for each added keyword(s) 750 and similar keyword(s) based on broad match, broad match modify, phase math, exact match, negative match. In an embodiment based on number of advertisers, number of posts posted by advertisers to number of selected or added keywords and similar keywords and target criteria specific number of identified users who searched said added keywords and similar keywords specific contents, bid by advertiser and estimated capacity to view number of posts by particular number of viewers (based on past per day or number of days or date & time ranges specific number of viewers), server 110 determines placement rank of post or position of post or shared content item or message (e.g. show post in first or particular number of page, wherein each page may comprise particular number of posts e.g. 10—user can scroll to load more or user can tap on page number to view next set of posts or user can refresh or pull to refresh to view new) in target audience's feed or timeline or list of updates or web page or news feed or interface. In an embodiment server 110 push or presents number of posts posted by posting users or advertisers in target audience user's feed or newsfeed or timeline or inbox or list of updates or webpage or interface based on position rank or position rank within unread post or message or first post first push or present. If user not yet viewed pending post then user notifies about number of newly received posts. In an embodiment user can skip to view number of newly received posts. In an embodiment user can provide one or more types of preferences (discuss in FIG. 9) to receive preferences specific posts. In an embodiment auto identify user preferences based on user profile and one or more types of user data. In an embodiment viewing user is enable to posts as per categories, view based on search query, view as per sort order including source including brand, name, entity name or type, person name, category, website, product or service name & company or organization, date & time of posting, keyword, category, location, language, type of content including photo, video, live video stream, text, and any combination.

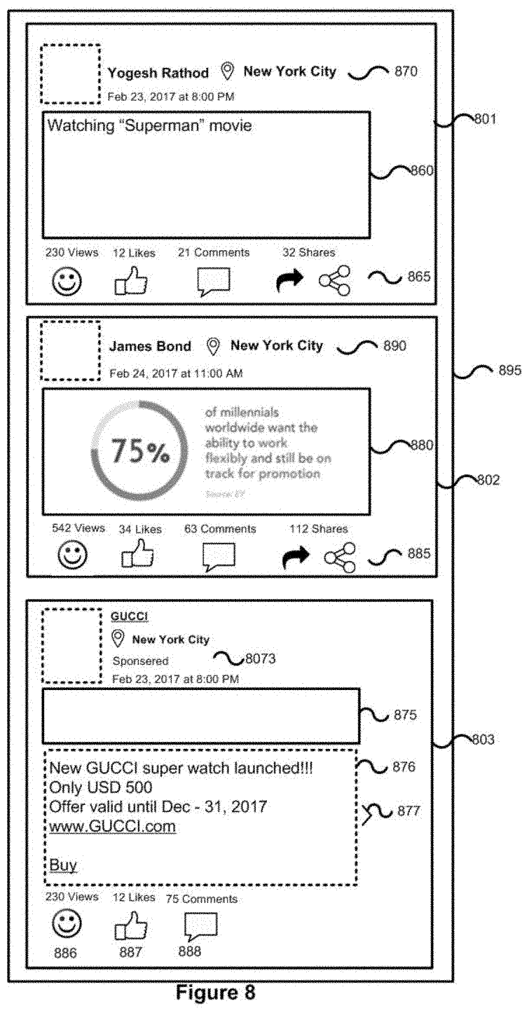

In an embodiment user or advertiser is enable to further filter said added keywords 750 or identified or selected similar or suggested keywords 785/790 identified searching users who searched said added keywords 750 or identified or selected similar or suggested keywords 785/790 specific contents based on selecting sources including users who searched said added keywords 750 or identified or selected similar or suggested keywords 785/790 specific contents from mobile, tablet, smart device, laptop, desktop, online website, application, 3^{rd} parties' websites or applications, device type including Android™, iOS, Windows™, selecting one or more types of user action(s) or call-to-action(s) 780, wherein searching user searched said added keywords 750 or identified or selected similar or suggested keywords 785/790 specific contents and conducted said selected one or more types of actions or call-to actions 780 including after searching based on said added or similar types of keyword(s) 750/785/790 specific contents, click on search result item, visit search result item associated or provided website or web page by clicking on link, buy product, subscribe service, make call, send message, fil form, click or tap on map & direction to find out direction or address, add to list, like, share, reply, provide comment, rating and review, include or exclude one or more locations, geo-fence specific, selected locations, categories of locations 782 (discuss in detail in FIG. 5 (E)) from where searching users searched said added keywords 750 or identified or selected similar or suggested keywords 785/790 specific contents, one or more attributes and characteristics 783 (discuss in detail in FIG. 5 (G)) including age range, gender, language, skill, education, income range, school, college, company, interest type, type of device, of searching users who searched said added keywords 750 or identified or selected similar or suggested keywords 785/790 specific contents, date and time ranges (771/772) from which said identified searching users searched said added keywords 750 or identified or selected similar or suggested keywords 785/790 specific contents. Based on said added keywords 750 or identified or selected similar or suggested keywords 785/790 and associated target audience criteria or conditions, server 110 presents number of identified or matched users 792 to enable user or advertiser reach 792. User or advertiser can enter 760, select 760, search & match 765, add one or more keywords 770 in list 751, select or un-select one or more similar or suggest keywords 785/790, update or add or remove or define or apply or set target audience criteria, rules, conditions, settings, preferences. In an embodiment based on selected payment model, terms, conditions, bid 798 and mode user can make payment 794 for sending, advertising, broadcasting, communicating, posting, and sharing one or more types of one or more contents or posts or messages. After defining and identifying target audience user or advertiser can post or send or broadcast or advertise one or more types of content items including photo, video, text, link, user action and any combination thereof 405 to said target audience or selected users from said identified or matched users on their news feed or feed or list of updates or web page or user profile or timeline or inbox or graphical user interface (GUI) (discuss or shown in FIG. 8) by tapping or clicking on “Post” or “Send” or “Broadcast”, “Update” button or link or icon or control. In an embodiment user can draft post 405, then select option 465, then select “Searched” action 555 and then add one or more keywords e.g. 750 and select similar keywords 785/790, select target audience criteria FIG. 7 (780/781/782/783/771/772/795/791/784) and FIG. 5 (E) and (G) and then user or advertiser can tap on “Post” 410 to present said posted one or more types of contents or post 803 to each target audience specific user's feed or list of updates or web page or timeline at user device. User or advertiser can view one or more types of analytics and statistics 799 including number of posts or shared contents or number of each type of shared or posted contents including photo, video, text, combination of photo, video, text, link and user actions, posts viewed by number of users, added keywords specific number of viewers, location, language, gender, age range, income range, interest type, device type, activity type, transaction type, categories, related one or more types and named entities including school, college, company, and organization, date & time range(s) specific number of viewers and number of type(s) of user actions or call-to-actions on posts, considerations or objects including send people to website or webpage, application installations, raise event attendance, get video views, collect leads, conversations including increase website conversions, increase application engagement, claim offers, promote a product catalogue, get people to visit a store.

FIG. 8 illustrates news feed or list of updates or list of updated contents or feed or timeline of user, wherein user can receive one or more types of contents, messages and posts including photo, video, text, link from one or more sources, advertisers, contacts, connections including friends & family, following sources or users of network, 3^{rd} parties web sites, servers, domains, providers and sources. As discussed in FIGS. 4-5, user receives one or more types of contents, messages and posts including photo, video, text, emoticons, image overlays, nodes, objects, user actions, link and any combination thereof from advertisers, followed advertisers and followed sources or users of network.

FIG. 9 illustrates graphical user interface (GUI) wherein user can provide preferences including one or more keywords 925, categories, tags and hashtags 910 and type(s) of contents 912 for receiving one or more types of contents from followed or subscribed accounts or followed users or sources. Option FIG. 4(459) utilizes said user preferences for identifying following users by matching user preferences with post e.g. 405 associated keywords, categories, tags, location, metadata, date & time, hashtags, link, recognized object inside photo or video associated keywords. Option FIG. 4(460) utilizes said user preferences for identifying liked users by matching user preferences with post e.g. 405 associated keywords, categories, tags, location, metadata, date & time, hashtags, link, recognized object inside photo or video associated keywords.

FIGS. 10-11 illustrates one or more types of detail user profile or various types of user details or user data. FIG. 4-5 utilizes various types of user profile for identifying one or more types of attributes or characteristics of user or identifying advertiser's criteria specific user, wherein profile may include age, gender, home & work or office location, current location, checked-in place, status, related entities including school, college, company, organization details, contacts, connections, language, types of interests, logged activities, actions, events, transactions, shared contents and associated metadata and system data, education, skills, marital status, income range, products and services used by user, contact information, job profile, business or professional profile and like.

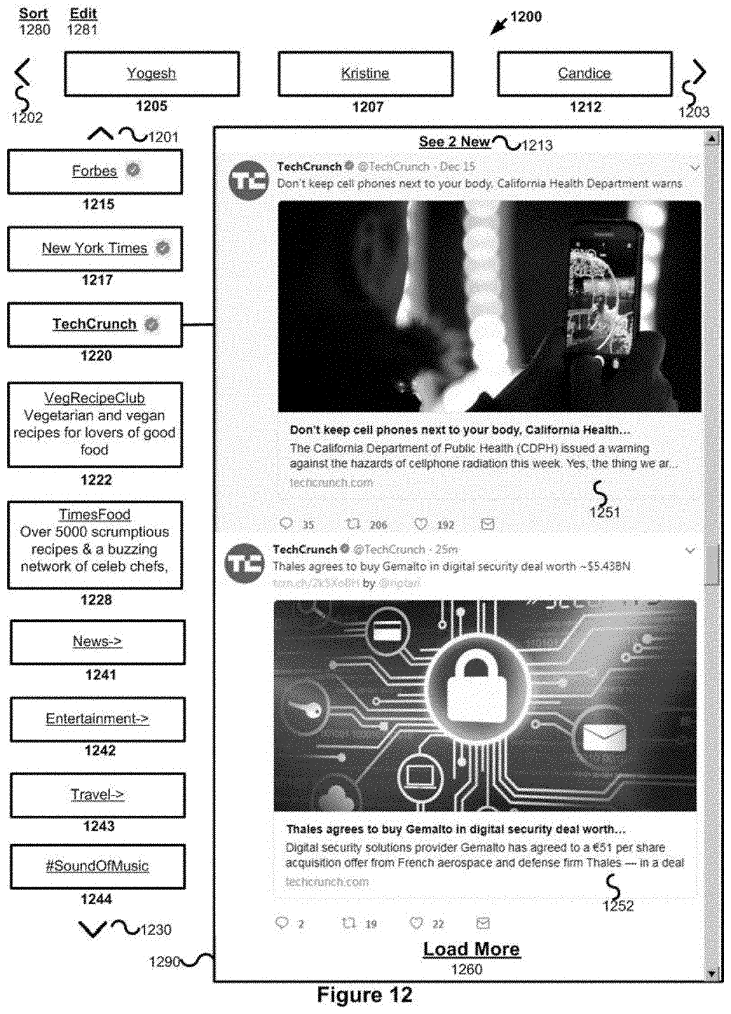

In another embodiment FIG. 2 illustrates various exemplary graphical user interface (GUI), wherein user can tap or click on “Add” button. For example when user taps or clicks on “Add” button 207 to add web page or profile page or business page 210 associated source or user or account to user's list for receiving updates or posted one or more types of contents from said web page or user profile or interface 210 associated user or account, server 110 stores 115 identity of user who added said web page or profile page or business page 210 associated source or user or account with identity of said added web page or profile page or business page 210 associated source or user or account 261. In another example user can search 225 people or users or sources or providers or accounts 221/226 for adding search result item associated source or user or account by tapping or clicking on “Add” button 222/227, wherein in the event of tapping or clicking on “Add” button e.g. 222 server 110 stores 115 identity of search result item associated source or user or account 261 with identity of user 265 who taps or clicks on “Add” button. In another example user can tap or click on “Add” button 236 associated with post or received shared content or message, 3^{rd} party web site, web page, application, blog, news, article, product details, service details, profile 233 and one or more types of contents or digital item(s) for receiving updates or posted one or more types of contents from said post or received shared content or message, 3^{rd} party web site, web page, application, blog, news, article, product details, service details, profile 233 associated user or source or provider or account, server 110 stores 115 identity of said added post or received shared content or message, 3^{rd} party web site, web page, application, blog, news, article, product details, service details, profile 233 associated source or user or provider or account 261 with identity of user 265 who added said post or received shared content or message, 3^{rd} party web site, web page, application, blog, news, article, product details, service details, profile 233 associated source or user or provider or account. In another example user can search 242 one or more types of contents 241/246 and can tap or click on search result item e.g. 241 associated or embedded or generated or integrated “Add” button 245, wherein in the event of tap or click on “Add” button 245, server 110 stores 115 identity of search result e.g. 241 item associated source or user or provider or account 261 with identity of user 265 who click or tap on “Add” button 245. FIG. 12 illustrates graphical user interface (GUI), wherein in the event of adding of sources or users or accounts or providers from various sources e.g. 210/220/230/240 by clicking or tapping on “Add” button e.g. 206/222/227/236/245/249 (as discuss above) to user's list for receiving updates or posted one or more types of contents from said added users or accounts or providers or sources, server 110 generates accessible tab or link or image or control for each added user or account or source or provider, wherein generated accessible tab or link or image or control comprise name or identity or nick name or account or source or provider name including person name, brand name, product name, service name, company name, movie name, web site name, category, keyword, hashtags, verified badge image or information and details, profile details, description, structured details of said tab associated source or user or entity or provider or account including user details, company details, product details, service details, date & time of joining, opening and closing of business or shop details, menu, timings, directions, contact information, price and like. After generating accessible tab or link or image or control for each added user or account or source or provider, server 110 presents or adds or embedded or integrate said generated accessible tab or link or image or control e.g. 1220 for each added user or account or source or provider with web page or one or more types of graphical user interface (GUI) 1290 for enabling said generated or updated webpage viewer to tap or click on said presented tab e.g. 1220 for viewing contents or updated or newly posted one or more types of contents 1290. User is enabled to edit said presented tab(s) by tapping on edit button 1281 to invoke edit mode, wherein edit include edit tab label, remove tab(s), add new tab(s) by selecting or searching and tapping on “Add” button or icon, and user is enabled to drag and drop to order tabs or tap on sort 1280 to sort tabs including sort as per added, auto rearrange as per recency of newly received one or more messages or posts or unread one or more messages or posts from tab(s) associated respective source(s), sort as per rank, sort as per ascending or descending order, sort as per categories, sort as per priority, bookmark or mark as per favorite. In an embodiment user is enabled to merge one or more tabs to view merged tab(s) associated source(s) related or updated contents. User is enabling to scroll or swipe to view tabs.

In an embodiment server 110 provides graphical user interface e.g. FIG. 4 (495) to posting user e.g. user or source or provider 261 associated with tab 1220 to draft or prepare or update one or more types of contents including photo, video, text, link and any combination thereof and post or update said contents, wherein server stores said newly posted or updated contents e.g. 293 with user identity e.g. 261 and notifies about number 1213 of newly revived one or more content item(s) or posts or messages from added sources (e.g. tab 1220 associated source) to viewing user on web page or graphical user interface (GUI) 1290 of viewing user. User can tap on link or icon or notification 103 to view newly received content item(s) or posts or messages from clicked or tapped tab e.g. 1220 associated source or user or provider or account. In the event of tapping or clicking by viewing user on any presented tab e.g. 1220, server 110 receives request to access said clicked or tapped tab associated contents or updated contents or feed. Server 110 retrieves said tab associated user's posted or related or stored contents from storage medium 115 and generates web page or graphical user interface (GUI) which comprises newly added user(s) or source(s) (if any) associated one or more tab(s), newly received or updated one or more content item(s) or post(s) or all contents or unread by viewing user in chronological order. After generating request specific web page or graphical user interface (GUI) 1290, server 110 presents said generated web page or graphical user interface (GUI) 1290 or 1200 to requesting user device.

In an another embodiment server 110 loads pre-set number of posts or messages or content item(s) in tab associated source related web page or graphical user interface (GUI) or feed interface 1290. User can instruct sever 110 to load next pre-set number of posts or messages or content item(s) in web page or graphical user interface (GUI) or feed interface 1290 by tapping or clicking on “Load More” link or icon or button or control 1260 for loading next pre-set number of posts or messages or content item(s) in web page or graphical user interface (GUI) or feed interface 1290.

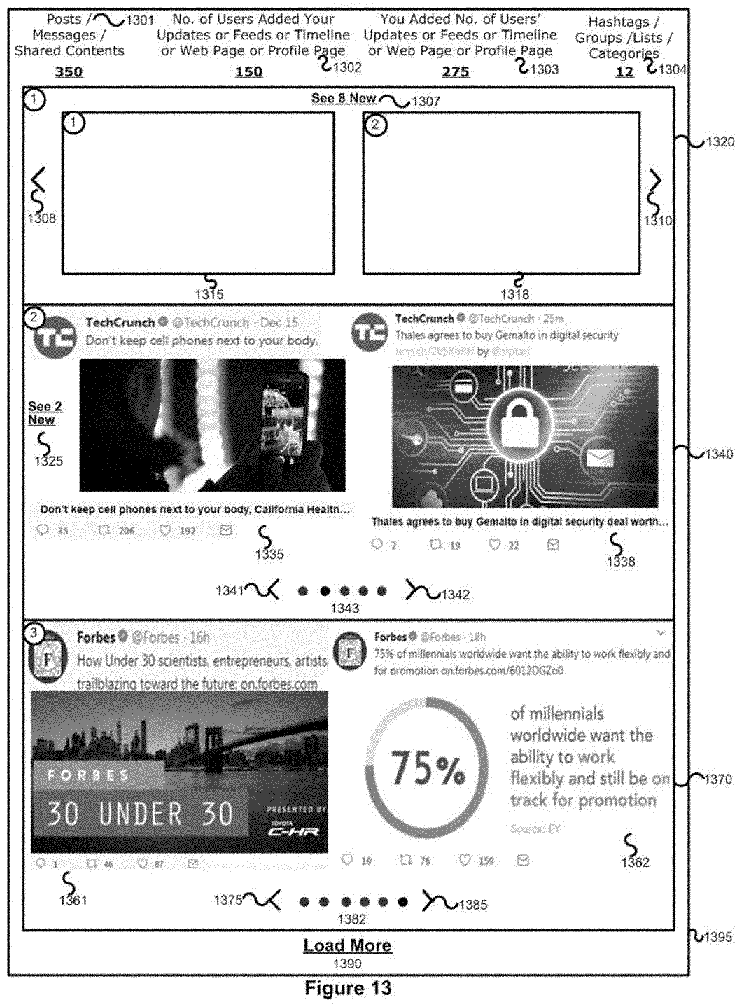

In another embodiment FIG. 13 illustrates web page or graphical user interface (GUI) 1195 wherein in the event of receiving request to access web page or graphical user interface (GUI) 1395 from requesting user, server 110 retrieves requesting user identity associated added or liked or followed sources or accounts or users or providers specific related posted or shared or stored one or more types of contents from storage medium 115 and generates and presents web page or graphical user interface (GUI) 1395 which vertically presents added or liked or followed each source or account or user or provider wise contents in most recently posted content source specific contents shown first in row then second most recently posted content source associated contents i.e. each row 1320/1340/1370 assign to each added or liked or followed each source or account or user or provider e.g. Techcrunch™ related all posts shown in 2^{nd} row in chronological order and then Forbes™ related all posts shown in 3^{rd} row in chronological order, wherein each added or liked or followed each source or account or user or provider specific retrieved contents or updated contents are vertically presented in chronological order i.e. each row e.g. 1320 associated each column e.g. 1315/118 shows posts or shared contents associated with row e.g. 1320 associated source e.g. Techcrunch™. So viewing user can vertically view each source or followed source specific all contents in chronological order (FIG. 13) instead of vertically show posts chronologically from all sources (e.g. in Twitter™ feed or Facebook™ Newsfeed). Based on receiving of new posts or unread posts, source associated with latest post shown in priority order in row. In an embodiment user notifies 1307 about receiving of number of new content from added sources and in the event of tap on notification or link or message 1307, user is presented with newly received message associates sources specific re-ordered rows. In an embodiment user is notify 1325 about receiving of number of new or unread messages or posts from particular added source and in the event of tapping or clicking on said notification 1325, user can view new messages (e.g. 2 new messages) from said added source without re-ordering of rows and based on view system updates number of new or unread posts notification 1307 (e.g. “See 6 New”) instead of (e.g. “See 8 New”).

In an embodiment viewing user page is parent webpage or interface and each added source related webpage is child webpage, wherein parent webpage shows or integrates or embedded or merges with child webpages inside parent webpage to show contents of each added sources in parent webpage.

In an embodiment user to user content sharing platform, user is presented with interface e.g. 495 to enabling user to prepare or draft or update post or one or more types of contents including photo, video, text, link and any combination thereof, user is enabling to search 225 one or more other users of network to select and add 222 them to list of added source of searching user, user is enabled to search 242 other users and content posted by other users of network based on user profile, user posted or shared messages or contents and add 245 them to list of added source of searching user, user is enabled to visit profile pages or business pages 210 of other users or advertisers of network and can add 206 them to list of added source of user, user is enabled to tap on e.g. “Add” 236 button or icon or link or control integrated or embedded with 3^{rd} parties websites, webpages, applications, contents, search result items and categories list items 233 and add 236 them to list of added source of user for receiving each posted contents 405 from said each added sources on user's feed or timeline or list of updates (FIG. 8).

In an embodiment user can scroll presented or received messages or posts from left to right 1310/1342/1375 or from right to left 1308/1341/1385 or user can directly jump on particular number of message or new message by tapping on icon preferred 1343. So each added source assigned one row in user's webpage or interface and each row vertically (e.g. each column) shows each posts of said row associated source, so user can vertically scroll and view all posts form said row associated source. Order of each row changes based on new message posted by said row associated source(s) i.e. newest message posted source associated row appears first in list of rows. Likewise vertically user is presented with newest post first from row associated source.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

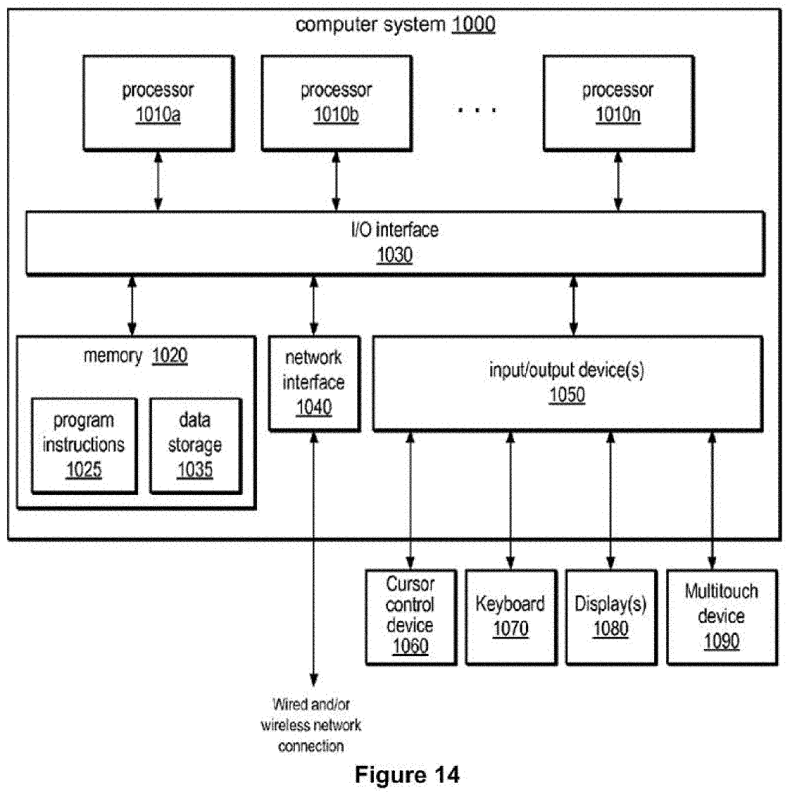

Various components of embodiments of methods as illustrated and described in the accompanying description may be executed on one or more computer systems, which may interact with various other devices. One such computer system is illustrated by FIG. 14. In different embodiments, computer system 1000 may be any of various types of devices, including, but not limited to, a personal computer system, desktop computer, laptop, notebook, or notebook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired and/or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired and/or wireless connection, such as over network interface 1040.

As shown in FIG. 14, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

In an embodiment a program is written as a series of human understandable computer instructions that can be read by a compiler and linker, and translated into machine code so that a computer can understand and run it. A program is a list of instructions written in a programming language that is used to control the behavior of a machine, often a computer (in this case it is known as a computer program).A programming language's surface form is known as its syntax. Most programming languages are purely textual; they use sequences of text including words, numbers, and punctuation, much like written natural languages. On the other hand, there are some programming languages which are more graphical in nature, using visual relationships between symbols to specify a program. In computer science, the syntax of a computer language is the set of rules that defines the combinations of symbols that are considered to be a correctly structured document or fragment in that language. This applies both to programming languages, where the document represents source code, and markup languages, where the document represents data. The syntax of a language defines its surface form. Text-based computer languages are based on sequences of characters, while visual programming languages are based on the spatial layout and connections between symbols (which may be textual or graphical or flowchart(s)). Documents that are syntactically invalid are said to have a syntax error. Syntax—the form—is contrasted with semantics—the meaning. In processing computer languages, semantic processing generally comes after syntactic processing, but in some cases semantic processing is necessary for complete syntactic analysis, and these are done together or concurrently. In a compiler, the syntactic analysis comprises the frontend, while semantic analysis comprises the backend (and middle end, if this phase is distinguished). There are millions of possible combinations, sequences, ordering, permutations & formations of inputs, interpretations, and outputs or outcomes of set of instructions of standardized or specialized or generalized or structured or functional or object oriented programming language(s).

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

I claim:

1. The method comprise:
a) receiving request to access and view updated contents or posts of added users by requesting user;
b) retrieving one or more types of contents or posts associated with each said added users;
c) generating web page or user interface comprises said retrieved contents or posts of each said added users, wherein vertically order row representing each added user based on date and time of new or updated posted contents or posts by added users and horizontally order contents or posts posted or updated by each said corresponding added users in chronological order; and
d) displaying said generated web page or user interface.

2. The method of claim 1 wherein enabling user to add other users of network in consolidated feed or timeline based on searching of profiles including user names or user identities of users of network and tapping or clicking on search result item associated embedded or integrated or presented button or icon or link or control.

3. The method of claim 1 wherein enabling user to add other users of network in consolidated feed or timeline based on searching of posted contents or posts of users of network by tapping or clicking on search result item associated embedded or integrated or presented button or icon or link or control to add source(s) associated with search contents.

4. The method of claim 1 wherein enabling user to add other users of network in consolidated feed or timeline based on visiting web site or profile page or web page of user(s) and tapping or clicking on profile page or webpage associated embedded or integrated or presented button or icon or link or control.

5. The method of claim 1 wherein displaying number of new or updated contents or posts by added users in timeline or feed of corresponding added users.

6. The method of claim 1 wherein automatically order timeline or feed of added users based on date and time of received or posted new or updated contents or posts by added users.

7. The method of claim 1 wherein enabling user to remove or hide post or content item from consolidated feed or timelines of added users.

8. The method of claim 1 wherein enabling user to remove or hide feed or timeline of added users.

9. The method of claim 1 wherein enabling user to manually order feed or timeline of added users.

10. The method of claim 1 wherein enabling user to swipe or scroll left to right or right to left in particular row or horizontal feed or timeline related to said row associated added user to view posted or updated posts or contents.

11. The system comprise:
e) receive request to access and view updated contents or posts of added users by requesting user;
f) retrieve one or more types of contents or posts associated with each said added users;
g) generate web page or user interface comprises said retrieved contents or posts of each said added users, wherein vertically order row representing each added user based on date and time of new or updated posted contents or posts by added users and horizontally order contents or posts posted or updated by each said corresponding added users in chronological order; and
h) display said generated web page or user interface.

12. The system of claim 11 wherein enable user to add other users of network in consolidated feed or timeline based on searching of profiles including user names or user identities of users of network and tapping or clicking on search result item associated embedded or integrated or presented button or icon or link or control.

13. The system of claim 11 wherein enable user to add other users of network in consolidated feed or timeline based on searching of posted contents or posts of users of network by tapping or clicking on search result item associated embedded or integrated or presented button or icon or link or control to add source(s) associated with search contents.

14. The system of claim 11 wherein enable user to add other users of network in consolidated feed or timeline based on visiting web site or profile page or web page of user(s) and tapping or clicking on profile page or webpage associated embedded or integrated or presented button or icon or link or control.

15. The system of claim 11 wherein display number of new or updated contents or posts by added users in timeline or feed of corresponding added users.

16. The system of claim 11 wherein automatically order timeline or feed of added users based on date and time of received or posted new or updated contents or posts by added users.

17. The system of claim 11 wherein enable user to remove or hide post or content item from consolidated feed or timelines of added users.

18. The system of claim 11 wherein enable user to remove or hide feed or timeline of added users.

19. The system of claim 11 wherein enable user to manually order feed or timeline of added users.

20. The system of claim 11 wherein enable user to swipe or scroll left to right or right to left in particular row or horizontal feed or timeline related to said row associated added user to view posted or updated posts or contents.
